(19) United States
(12) Patent Application Publication
(10) Pub. No.: US 2013/0108702 A1
(43) Pub. Date: May 2, 2013

(54) COPPER/SILICA NANOPARTICLES, METHODS OF MAKING, AND METHODS OF USE

(71) Applicant: Swadeshmukul Santra, Orlando, FL (US)

(72) Inventor: Swadeshmukul Santra, Orlando, FL (US)

(21) Appl. No.: 13/664,463

(22) Filed: Oct. 31, 2012

Related U.S. Application Data
(60) Provisional application No. 61/554,286, filed on Nov. 1, 2011.

(51) Int. Cl. A01N 25/26; B05D 7/24; A01N 59/20

(52) U.S. Cl. 424/490; 424/630; 427/217

(57) ABSTRACT

Embodiments of the present disclosure, in one aspect, relate to compositions including a copper/silica nanostructure, methods of making a copper/silica nanostructure, methods of using a copper/silica nanostructure, and the like.

### CLAIM OF PRIORITY TO RELATED APPLICATION

This application claims priority to co-pending U.S. provisional application entitled “Novel Copper (Cu) Loaded Core-Shell Silica Nanoparticles with Improved Cu Bioavailability” having Ser. No. 61/542,286, filed on Nov. 2, 2011, which is entirely incorporated herein by reference.

### FEDERAL SPONSORSHIP

This invention was made with Government support under Contract/Grant No. 0506560, awarded by the National Science Foundation. The Government has certain rights in this invention.

### BACKGROUND

Biocidal properties of copper (Cu) compounds have been known for centuries. Studies have shown that Cu compounds are effective in preventing infection in plants and in human subjects. Copper is being introduced as an active antimicrobial agent in food packaging, as wood preservatives, as antifouling agents in fabrics and paint based materials. In healthcare facilities, Cu alloy based materials are becoming popular as anti-bacterial touch surface materials after receiving approval from the US-EPA. It is highly anticipated that such Cu based touch surface materials will protect spreading of hospital acquired bacterial infection, including antibiotic resistant bacterial infection such as Methicillin-Resistant Staphylococcus Aureus (MRSA). Hospital acquired infections are the fourth largest killer in the USA. The increase in using copper for its biocidal properties may pose a threat to the environment, in particular, water systems. Thus, there is a need to reduce the amount of copper that can be introduced into the environment.

### SUMMARY

In accordance with the purpose(s) of the present disclosure, as embodied and broadly described herein, embodiments of the present disclosure, in one aspect, relate to compositions including a copper/silica nanostructure, methods of making a copper/silica nanostructure, methods of using a copper/silica nanostructure, and the like.

In an embodiment, a composition, among others, includes: a copper/silica nanoparticle having a silica core and a copper/silica shell disposed around the silica core, wherein the copper is about 2 to 30 weight percent of the copper/silica nanoparticle, wherein the copper is uniformly loaded in the copper/silica shell.

In an embodiment, a method of making a composition, among others, includes: mixing a first silica precursor compound, an alcohol, ammonium hydroxide, and water; forming a silica core; separating the silica core from the remaining mixture; mixing the silica core in an acidic solution with a copper precursor compound and a second silica precursor compound; and forming a copper/silica nanoparticle having a silica core and a copper/silica shell disposed around the silica core, wherein the copper is about 2 to 30 weight percent of the copper/silica nanoparticle, wherein the copper is uniformly loaded in the copper/silica shell.

In an embodiment, a method, among others, includes: disposing a composition on a surface, wherein the composition include a copper/silica nanoparticle having a silica core and a copper/silica shell disposed around the silica core, wherein the copper is about 2 to 30 weight percent of the copper/silica nanoparticle, wherein the copper is uniformly loaded in the copper/silica shell; and killing a substantial portion of a microorganism or inhibiting or substantially inhibiting the growth of the microorganisms on the surface of a structure or that come into contact with the surface of the structure.

Other systems, methods, features, and advantages will be, or become, apparent to one with skill in the art upon examination of the following drawings and detailed description. It is intended that all such additional structures, systems, methods, features, and advantages be included within this description, be within the scope of the present disclosure, and be protected by the accompanying claims.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1.1 illustrates SEM images showing particle size and surface morphology for (a) ˜380 nm size SiNP and (b) ˜445 nm size C—S CuSiO₂NP. The increase in particle size for C—S CuSiO₂NP confirms the seeded growth of copper-silica shell around the core silica “seed’ nanoparticles. TEM image of ˜380 nm size SiNP (c) and ˜445 nm size C—S CuSiO₂NP (d). The differentiation between core and shell could not be seen due to large size particles. The average particle size was obtained as a mean of 50 particles in both SEM and TEM.

FIG. 1.2 illustrates SEM-EDS compositional analysis confirms Cu loading in C—S CuSiO₂NP material as it shows characteristic Cu peak.

FIG. 1.3 illustrates AFM images of (a) SiNPs and (b) C—S CuSiO₂NPs. AFM images are consistent with the SEM and the TEM images, confirming formation of monodispersed particles.

FIG. 1.4 illustrates DLS particle size distribution profile (a) SiNPs and (b) C—S CuSiO₂NPs in solution at neutral pH. Relatively broad distribution of particle size for the C—S CuSiO₂NPs is observed in comparison to the SiNPs, indicative of increased particle-particle interaction in C—S CuSiO₂NPs.

FIG. 1.5 illustrates a histogram showing relative inhibition of growth of (a) E. coli and (b) B. subtilis using turbidity in presence of C—S CuSiO₂NP at a concentration of 0.24, 0.49, 1.2, 2.4, 4.9, 7.2 and 9.6 μg of metallic Cu/mL of test solution. Control particles were Stöber silica (“seed” particles) and sub-micron size Cu hydroxide particles DuPont™ Kocide® 3000 at two different metallic copper concentrations of 4.9 μg/mL and 2.4 μg/mL. As expected, bacterial suspension containing no nanoparticles exhibited maximum growth.

FIG. 1.6 illustrates plates showing the color change in resazurin assay method to find MIC of C—S CuSiO₂NP against E. coli (a) and B. subtilis (b). C—S CuSiO₂NP at 9.6 (A1), 4.9 (A2), 3.6 (A3), 2.4 (A4) and 1.2 (B1) μg of copper/mL of test solution was considered. Kocide® 3000 was the positive control at copper concentrations 9.6 (B2), 4.9 (B3), 3.6 (B4), 2.4 (C1) and 1.2 (C2) μg/mL of test solution. Silica nanoparticle was the negative control (C4). One well was maintained as control for the organism (C3).

FIG. 1.7 illustrates fluorescent microscopy (confocal) images of E. coli (a, b) and B. subtilis (c, d) treated with C—S CuSiO₂NP (4.9 μg metallic Cu/mL). Fluorescence images were collected through green (a, c) and red (b, d) channels using appropriate filter sets for green-fluorescent SYTO® 9 stain and red-fluorescent propidium iodide stain.

FIG. 2.1 illustrates SEM images of SiNP ˜380 nm (a) and C—S CuSiNP ˜450 nm (b) showing particle size and morphology.

FIG. 2.2 illustrates (a) HRTEM micrograph of AgSiNG showing the presence of silver nanoparticles in amorphous silica gel and (b) HRTEM-electron diffraction pattern of silver nanoparticles present in the AgSiNG material.

FIG. 2.3 illustrates histograms showing inhibition of E. coli in liquid media by C—S CuSiNP (a). Silica nanoparticle was used as negative control. Copper sulfate with equivalent metallic copper concentration was used as positive control as shown in (b).

FIG. 2.4 illustrates histograms showing inhibition of B. subtilis in liquid media by C—S CuSiNP (a). Silica nanoparticle was used as negative control. Copper sulfate with equivalent metallic copper concentration was used as positive control as shown in (b).

FIG. 2.5 illustrates histograms showing inhibition of E. coli in liquid media by AgSiNG (a). Silica nanogel was used as negative control. Silver nitrate with equivalent metallic silver concentration was used as positive control as shown in (b).

FIG. 2.6 illustrate histograms showing inhibition of B. subtilis in liquid media by AgSiNG (a). Silica nanogel was used as negative control. Silver nitrate with equivalent metallic copper concentration was used as positive control as shown in (b).

FIG. 2.7 illustrates fluorescent microscopy images of E. coli (a) and B. subtilis (b) showing live/dead cells on treatment with C—S CuSiNP material.

FIG. 2.8 illustrates fluorescent microscopy images of E. coli (a) and B. subtilis (b) showing live/dead cells on treatment with AgSiNG material.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer chemistry, biology, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmospheres. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DEFINITIONS

The term “antimicrobial characteristic” refers to the ability to kill and/or inhibit the growth of microorganisms. A substance having an antimicrobial characteristic may be harmful to microorganisms (e.g., bacteria, fungi, protozoans, algae, and the like). A substance having an antimicrobial characteristic can kill the microorganism and/or prevent or substantially prevent the growth or reproduction of the microorganism.

The term “antibacterial characteristic” refers to the ability to kill and/or inhibit the growth of bacteria. A substance having an antibacterial characteristic may be harmful to bacteria. A substance having an antibacterial characteristic can kill the bacteria and/or prevent or substantially prevent the replication or reproduction of the bacteria.

The terms “alk” or “alkyl” refer to straight or branched chain hydrocarbon groups having 1 to 12 carbon atoms, preferably 1 to 8 carbon atoms, such as methyl, ethyl, n-propyl, i-propyl, n-butyl, i-butyl, t-butyl, pentyl, hexyl, heptyl, n-octyl, dodecyl, octadecyl, amyl, 2-ethylhexyl, and the like. Alkyl can include alkyl, dialkyl, trialkyl, and the like.

The terms “bacteria” or “bacterium” include, but are not limited to, Gram positive and Gram negative bacteria. Bacteria can include, but are not limited to, Abiotrophia, Achromobacter, Acidaminococcus, Acidovorax, Acinetobacter, Actinobacillus, Actinobaculum, Actinomadura, Actinomyces, Aerococcus, Aeromonas, Afipia, Agrobacterium, Alcaligenes, Alloiococcus, Alteromonas, Amycolata, Amycolatopsis, Anaerobospirillum, Anabaena affinis and other cyanobacteria (including the Anabaena, Anabaenopsis, Aphanizomenon, Carnesiphon, Cylindrospermopsis, Gloeobacter Hapalosiphon, Lyngbya, Microcystis, Nodularia, Nostoc, Phormidium, Planktothrix, Pseudoanabaena, Schizothrix, Spirulina, Trichodesmium, and Umezakia genera) Anaerorhabdus, Arachnia, Arcanobacterium, Arcobacter, Arthrobacter, Atopobium, Aureobacterium, Bacteroides, Balneatrix, Bartonella, Bergeyella, Bifidobacterium, Bilophila Branhamella, Borrelia, Bordetella, Brachyspira, Brevibacillus, Brevibacterium, Brevundimonas, Brucella, Burkholderia, Buttiauxella, Butyrivibrio, Calymmatobacterium, Campylobacter, Capnocytophaga, Cardiobacterium, Catonella, Cedecea, Cellulomonas, Centipeda, Chlamydia, Chlamydophila, Chromobacterium, Chyseobacterium, Chryseomonas, Citrobacter, Clostridium, Collinsella, Comamonas, Corynebacterium, Coxiella, Cryptobacterium, Delftia, Dermabacter, Dermatophilus, Desulfomonas, Desulfovibrio, Dialister, Dichelobacter, Dolosicoccus, Dolosigranulum, Edwardsiella, Eggerthella, Ehrlichia, Eikenella, Empedobacter, Enterobacter, Enterococcus, Erwinia, Erysipelothrix, Escherichia, Eubacterium, Ewingella, Exiguobacterium, Facklamia, Filifactor, Flavimonas, Flavobacterium, Francisella, Fusobacterium, Gardnerella, Gemella, Globicatella, Gordona, Haemophilus, Hafnia, Helicobacter, Helococcus, Holdemania Ignavigranum, Johnsonella, Kingella, Klebsiella, Kocuria, Koserella, Kurthia, Kytococcus, Lactobacillus, Lactococcus, Lautropia, Leclercia, Legionella, Leminorella, Leptospira, Leptotrichia, Leuconostoc, Listeria, Listonella, Megasphaera, Methylobacterium, Microbacterium, Micrococcus, Mitsuokella, Mobiluncus, Moellerella, Moraxella, Morganella, Mycobacterium, Mycoplasma, Myroides, Neisseria, Nocardia, Nocardiopsis, Ochrobactrum, Oeskovia, Oligella, Orientia, Paenibacillus, Pantoea, Parachlamydia, Pasteurella, Pediococcus, Peptococcus, Peptostreptococcus, Photobacterium, Photorhabdus, Phytoplasma, Plesiomonas, Porphyrimonas, Prevotella, Propionibacterium, Proteus, Providencia, Pseudomonas, Pseudonocardia, Pseudoramibacter, Psychrobacter, Rahnella, Ralstonia, Rhodococcus, Rickettsia Rochalimaea Roseomonas, Rothia, Ruminococcus, Salmonella, Selenomonas, Serpulina, Serratia, Shewenella, Shigella, Simkania, Slackia, Sphingobacterium, Sphingomonas, Spirillum, Spiroplasma, Staphylococcus, Stenotrophomonas, Stomatococcus, Streptobacillus, Streptococcus, Streptomyces, Succinivibrio, Sutterella, Suttonella, Tatumella, Tissierella, Trabulsiella, Treponema, Tropheryma, Tsakamurella, Turicella, Ureaplasma, Vagococcus, Veillonella, Vibrio, Weeksella, Wolinella, Xanthomonas, Xenorhabdus, Yersinia, and Yokenella. Other examples of bacterium include Mycobacterium tuberculosis, M. bovis, M. typhimurium, M. bovis strain BCG, BCG substrains, M. avium, M. intracellulare, M. africanum, M. kansasii, M. marinum, M. ulcerans, M. avium subspecies paratuberculosis, Staphylococcus aureus, Staphylococcus epidermidis, Staphylococcus equi, Streptococcus pyogenes, Streptococcus agalactiae, Listeria monocytogenes, Listeria ivanovii, Bacillus anthracis, B. subtilis, Nocardia asteroides, and other Nocardia species, Streptococcus viridans group, Peptococcus species, Peptostreptococcus species, Actinomyces israelii and other Actinomyces species, and Propionibacterium acnes, Clostridium tetani, Clostridium botulinum, other Clostridium species, Pseudomonas aeruginosa, other Pseudomonas species, Campylobacter species, Vibrio cholera, Ehrlichia species, Actinobacillus pleuropneumoniae, Pasteurella haemolytica, Pasteurella multocida, other Pasteurella species, Legionella pneumophila, other Legionella species, Salmonella typhi, other Salmonella species, Shigella species Brucella abortus, other Brucella species, Chlamydi trachomatis, Chlamydia psittaci, Coxiella burnetti, Escherichia coli, Neiserria meningitidis, Neiserria gonorrhea, Haemophilus influenzae, Haemophilus ducreyi, other Hemophilus species, Yersinia pestis, Yersinia enterolitica, other Yersinia species, Escherichia coli, E. hirae and other Escherichia species, as well as other Enterobacteria, Brucella abortus and other Brucella species, Burkholderia cepacia, Burkholderia pseudomallei, Francisella tularensis, Bacteroides fragilis, Fudobascterium nucleatum, Provetella species, and Cowdria ruminantium, or any strain or variant thereof. The Gram-positive bacteria may include, but is not limited to, Gram positive Cocci (e.g., Streptococcus, Staphylococcus, and Enterococcus). The Gram-negative bacteria may include, but is not limited to, Gram negative rods (e.g., Bacteroidaceae, Enterobacteriaceae, Vibrionaceae, Pasteurellae and Pseudomonadaceae). In an embodiment, the bacteria can include Mycoplasma pneumoniae.

The term “protozoan” as used herein includes, without limitations flagellates (e.g., Giardia lamblia), amoeboids (e.g., Entamoeba histolitica), and sporozoans (e.g., Plasmodium knowlesi) as well as ciliates (e.g., B. coli). Protozoan can include, but it is not limited to, Entamoeba coli, Entamoeabe histolitica, Iodoamoeba buetschlii, Chilomastix meslini, Trichomonas vaginalis, Pentatrichomonas homini, Plasmodium vivax, Leishmania braziliensis, Trypanosoma cruzi, Trypanosoma brucei, and Myxoporidia.

The term “algae” as used herein includes, without limitations microalgae and filamentous algae such as Anacystis nidulans, Scenedesmus sp., Chlamydomonas sp., Clorella sp., Dunaliella sp., Euglena so., Prymnesium sp., Porphyridium sp., Synechoccus sp., Botryococcus braunii, Crypthecodinium cohnii, Cylindrotheca sp., Microcystis sp., Isochrysis sp., Monallanthus salina, M. minhuman, Nannochloris sp., Nannochloropsis sp., Neochioris oleoabundans, Nitzschia sp., Phaeodactylum tricornutum, Schizochytrium sp., Senedesmus ohliquus, and Tetraselmis sueica as well as algae belonging to any of Spirogyra, Cladophora, Vaucheria, Pithophora and Enteromorpha genera.

The term “fungi” as used herein includes, without limitations, a plurality of organisms such as molds, mildews and rusts and include species in the Penicillium, Aspergillus, Acremonium, Cladosporium, Fusarium, Mucor, Nerospora, Rhizopus, Tricophyton, Botryotinia, Phytophthora, Ophiostoma, Magnaporthe, Stachybotrys and Uredinalis genera.

### Discussion:

In accordance with the purpose(s) of the present disclosure, as embodied and broadly described herein, embodiments of the present disclosure, in one aspect, relate to compositions including a copper/silica nanostructure, methods of making a copper/silica nanostructure, methods of using a copper/silica nanostructure, and the like. An advantage of an embodiment of the present disclosure includes increasing Cu bioavailability. In an embodiment, copper bioavailability (i.e., more soluble Cu) and particle retention can be increased by reducing particle size and using hybrid silica shell composition (using more than one silica precursors).

In an embodiment, the composition can be used as an antimicrobial agent to kill and/or inhibit the formation of microorganisms on a surface. An advantage of the present disclosure is that the composition is effective as an antimicrobial agent but the amount of copper in the copper/silica nanostructure is substantially reduced and the copper is relatively more soluble than other sources of copper used.

In an embodiment, the composition that includes the copper/silica nanostructure may have an antimicrobial characteristic (e.g., kills at least 70%, at least 80%, at least 90%, at least 95%, or at least 99% of the microorganisms (e.g., bacteria) on the surface and/or reduces the amount of microorganisms that form or grow on the surface by at least 70%, at least 80%, at least 90%, at least 95%, or at least 99%, as compared to a similar surface without the composition disposed on the surface). In an embodiment, the copper/silica nanoparticle has a minimum inhibitory concentration (MIC) value of about 2.4 μg metallic Cu/mL (e.g., 2.4 μg metallic Cu/mL±10%) for both E. coli and B. subtilis. Additional details are described in the Examples.

In an embodiment, the composition including the copper/silica nanostructure can be disposed on a surface of a structure. In an embodiment, the structure can include those that may be exposed to microorganisms and/or that microorganisms can grow on such as, without limitation, fabrics, cooking counters, food processing facilities, kitchen utensils, food packaging, swimming pools, metals, drug vials, medical instruments, medical implants, yarns, fibers, gloves, furniture, plastic devices, toys, diapers, leather, tiles, and flooring materials. In an embodiment, the structure can include textile articles, fibers, filters or filtration units (e.g., HEPA for air and water), packaging materials (e.g., food, meat, poultry, and the like food packaging materials), plastic structures (e.g., made of a polymer or a polymer blend), glass or glass like structures on the surface of the structure, metals, metal alloys, or metal oxides structure, a structure (e.g., tile, stone, ceramic, marble, granite, or the like), and a combination thereof.

As mentioned above, the composition includes a copper/silica nanostructure. In an embodiment, the copper/silica nanostructure includes a silica core and a copper/silica shell surrounding the silica core. Since the copper/silica nanostructure includes a silica core, the total amount of copper in the copper/silica nanostructure is reduced relative to nanostructures where the copper is distributed throughout the structure. The copper in the copper/silica shell is exposed on the surface of the copper/silica nanostructure so that it can act as an antimicrobial agent. The amount of copper in the copper/silica shell can be controlled. Thus, an advantage of an embodiment of the present disclosure is that the amount of copper per particle is reduced by spreading Cu in the shell of a core-shell particles relative to nanoparticles having copper throughout the nanoparticle.

In an embodiment, the diameter of the particles (e.g., silica core) or shell (e.g., copper/silica shell) can be varied from a few nanometers to hundreds of nanometers by appropriately adjusting synthesis parameters, such as amounts of precursor compound(s), polarity of reaction medium, pH, time or reaction, and the like. For example, the diameter of the particles or shell can be controlled by adjusting the time frame of the reaction. In an embodiment, the copper/silica nanostructure can be spherical or substantially spherical. In an embodiment, the diameter of the silica core can be about 10 nm to 1 μm or about 50 nm to 200 nm. In an embodiment, the thickness of the copper/silica shell can be about 5 nm to 200 nm or about 5 nm to 50 nm. In an embodiment, the copper/silica shell may have a uniform thickness or may not have a uniform thickness.

In addition, the amount of copper loading in the copper/silica shell can be controlled by appropriately adjusting synthesis parameters, such as amounts of precursor compound(s), polarity of reaction medium, pH, time or reaction, and the like. In an embodiment, the copper loading in the copper/silica shell can be about 2 to 30 weight percent or about 5 to 15 weight percent, of the copper/silica nanostructure. In an embodiment, the copper in the copper/silica shell is about 5 to 20% more soluble than copper hydroxide (which has a solubility product (Kₛₚ) of about 2.2×10⁻²⁰).

In general, this process can be performed in two steps: formation of the silica core (e.g., base-hydrolyzed Stöber silica “seed” particle) and the formation of the copper/silica shell around the core. In an embodiment, a silica nanoparticle can be made by mixing a first silica precursor material such as a silane compound (e.g., alkyl silane, tetraethoxysilane (TEOS), tetramethoxysilane, sodium silicate, or a silane precursor that can produce silicic acid or silicic acid like intermediates and a combination of these silane compounds) with an alcohol (e.g., ethanol, propanol, butanol, and the like), and ammonium hydroxide. In an embodiment, the mixture can be mixed for about 30 minutes to 6 hours and sonicated for about 5 min to 1 hour all at room temperature. Once the silica nanoparticles (silica shell) are formed, they can be separated from the remaining mixture and rinsed as needed. The silica nanoparticles can be mixed in an acidic medium (e.g., acidic water) with a copper precursor compound (e.g., copper sulfate pentahydrate, copper nitrate, copper chloride, and the like) and a silica precursor compound (second silica precursor compound), such as those described above, all at room temperature for about 15 min to 24 hours. It should be noted that the first and second silica precursor compounds can be the same or different. In an embodiment, the molar ratio of the second silica precursor compound to the copper precursor compound can be about 30:1 to 1:1 or about 10:1 to 2:1. After mixing for a period of time, a mixture including copper/silica nanoparticles can be formed and separated from the mixture.

In an embodiment, after the composition is disposed (e.g., sprayed, dip coating the structure, wiping the composition on the structure, and the like) on the surface, the structure may have an antimicrobial characteristic that is capable of killing a substantial portion of the microorganisms (e.g., bacteria such as E. coli, B. subtilis and S. aureus) on the surface of the structure and/or inhibits or substantially inhibits the growth of the microorganisms on the surface of the structure. The phrase “killing a substantial portion” includes killing at least about 70%, at least about 80%, at least about 90%, at least about 95%, or at least about 99% of the microorganism (e.g., bacteria) on the surface that the composition is disposed on, relative to structure that does not have the composition disposed thereon. The phrase “substantially inhibits the growth” includes reducing the growth of the microorganism (e.g., bacteria) by at least about 70%, at least about 80%, at least about 90%, at least about 95%, or at least about 99% of the microorganisms on the surface that the composition is disposed on, relative to a structure that does not have the composition disposed thereon.

### EXAMPLES

### Example 1

### Brief Introduction:

This Example describes a synthesis of a novel core-shell silica based antimicrobial nanoparticles where the silica shell has been engineered to accommodate copper (Cu). Synthesis of the core-shell Cu-silica nanoparticle (C—S CuSiO₂NP) involves preparation of base-hydrolyzed Stöber silica “seed” particles first, followed by the acid-catalyzed seeded growth of the Cu-silica shell layer around the core. The Scanning Electron Microscopy (SEM) and the Transmission Electron Microscopy (TEM) measured the seed particle size to be ˜380 nm and the shell thickness to be ˜35 nm. The SEM particle characterization confirms formation of highly monodispersed particles with smooth surface morphology. Characterization of particle size distribution in solution by Dynamic Light Scattering (DLS) technique was fairly consistent with the electron microscopy results. Loading of Cu to nanoparticles was confirmed by the SEM-Energy Dispersive X-Ray Spectroscopy (EDS) and Atomic Absorption Spectroscopy (AAS). The Cu loading was estimated to be 0.098 μg of metallic copper per mg of C—S CuSiO₂NP material by the AAS technique. Antibacterial efficacy of C—S CuSiO₂NP was evaluated against E. coli and B. subtilis using Cu hydroxide (“Insoluble” Cu compound, sub-micron size particles) as positive control and silica “seed” particles (without Cu loading) as negative control. Bacterial growth in solution was measured against different concentrations of C—S CuSiO₂NP to determine the Minimum Inhibitory Concentration (MIC) value. The estimated MIC values were 2.4 μg metallic Cu/mL for both E. coli and B. subtilis. Bac-light fluorescence microscopy based assay was used to count relative population of the live and dead bacteria cells. Antibacterial study clearly shows that C—S CuSiO₂NP is more effective than insoluble Cu hydroxide particles at equivalent metallic Cu concentration, suggesting improvement of Cu bioavailability (i.e. more soluble Cu) in C—SCuSiO₂NP material due to its core-shell design.

### Introduction:

Biocidal properties of copper (Cu) compounds have been known for centuries¹. Studies have shown that Cu compounds are effective in preventing infection in plants and in human subjects¹⁻⁵. Copper is being introduced as an active antimicrobial agent in food packaging⁶, as wood preservatives^{7, 8}, as antifouling agents in fabrics⁹ and paint based materials¹⁰. In healthcare facilities, Cu alloy based materials are becoming popular as anti-bacterial touch surface materials after receiving approval from the US-EPA^{4, 5}. It is highly anticipated that such Cu based touch surface materials will protect spreading of hospital acquired bacterial infection¹¹, including antibiotic resistant bacterial infection such as Methicillin-Resistant Staphylococcus Aureus^{12, 13}(MRSA). Hospital acquired infections are the fourth largest killer in the USA. A recent report by Weaver et al. suggests that rapid killing of MRSA by exposure to Cu surface is due to compromised cellular respiration and DNA damage⁴.

Copper compounds are widely used in agriculture as fungicide/bactericide to control plant diseases¹⁵. To obtain adequate protection against disease infection, repeated applications are required. For example, about 8-10 spray applications are required per season (March/April through October/November) to protect citrus canker disease (a devastating citrus disease caused by a bacterial pathogen, Xanthomonas axonopodis pv. citri)^{16, 17}. Repeated applications of Cu compounds not only result in accumulation of Cu in fertile agricultural soil, but also pose a threat to the environment¹⁸⁻²¹, in particular aquatic species¹⁸⁻²².

Extensive studies have been done on inorganic and metal based core-shell antibacterial nanoparticles such as silver²³⁻²⁶, zinc oxide²⁷, titanium dioxide²⁸⁻³¹ and copper³²⁻³⁴ where silica has been used as a host material. Most studies have been reported on Cu-oxide-silica composite materials in the area of catalysis where Cu-oxides are embedded in silica host matrix^{35, 36}. In general, these Cu based catalytic materials are prepared by annealing (high-temperature treatment, up to ˜900° C.) sol-gel derived Cu loaded silica material³⁵⁻³⁷ Kim et al³⁸ described synthesis of antibacterial copper loaded core-shell silica nanoparticles where Cu nanoparticles were deposited onto the surface of the silica nanoparticle. The synthesis method and the resulting structural morphology of these composite particles³⁸ were significantly different from the present. To the best of our knowledge, there is no report on the antibacterial studies of copper (Cu) loaded core-shell nanoparticles where Cu is uniformly loaded only in the silica shell during the shell growth process over the silica nanoparticle core.

It is evident that usage of antimicrobial Cu will continue to increase in the near future. In the present study our main goal is to reduce the amount of Cu in the material without compromising antibacterial activities. In particular, this paper is focused on efficient design of Cu embedded silica nanoparticle delivery platform. Since antibacterial efficacy of Cu is directly correlated to bioavailability of Cu ions, we present a novel core-shell Cu loaded silica nanoparticle (C—S CuSiO₂NP) design. The C—S CuSiO₂NP is composed of pure silica core and Cu loaded silica shell. Since Cu is distributed in the NP shell region, reduced amount of Cu will be required to obtain significant antibacterial efficacy. Furthermore, bioavailability of Cu is expected to increase in C—S CuSiO₂NP in comparison to Cu hydroxide (“insoluble” Cu compound such as Kocide® 3000 which is widely used as agricultural biocides) due to availability of more “soluble” Cu. Improving efficacy of Cu biocide has a clear advantage of reducing undesirable burden related to Cu toxicity in the environment.

### Materials and Methods

All reagents were purchased from commercial vendors and used without any further purification. Ethanol (95% V/V; Fisher Scientific), tetraethylorthosilicate (TEOS; Fisher Scientific), ammonium hydroxide (NH₃ content 28-30%; Sigma-Aldrich), concentrated hydrochloric acid (Fisher Scientific), copper sulfate pentahydrate (CQ concepts, Ringwood, Ill.), sodium chloride (Fisher Scientific). Kocide®03000, a product of DuPont™ was received as a gift from Dr. Jim Graham (Citrus Research and Education Center, Lake Alfred, Fla.). Luria Bertani (LB) broth and agar for antibacterial study were purchased from Fluka. E. coli strain ATCC 35218 and B. subtilis strain ATCC 9372 were provided by the Microbiology lab, University of Central Florida. Hydrion paper (Fisher Scientific) was used for pH measurements. Nanopure deionized water (Barnstead) was used throughout the study.

### Synthesis of Core-Shell Cu Loaded Silica Nanoparticles (C—S CuSio₂NPs)

The C—S CuSiO₂NPs were synthesized in two steps (step I and step II). In step I pure Stöber silica “seed” particles were synthesized using a published protocol by Rossi et al.³⁹. 1.3 mL Tetraethylorthosilicate (TEOS, a silane precursor for silica nanoparticles) and 5.7 mL ethanol (95% V/V) mixture were added to a solution of 13 mL ethanol (95% V/V), 7 mL ammonium hydroxide (28 to 30% V/V) and 3 mL water under stirring conditions. Stirring of the reaction mixture was continued at 400 rpm for an hour followed by sonication for 10 minutes using a sonic bath (Barnstead Elma 9322). SiNP purification procedure involved centrifugation and washing steps. Particles were isolated first from the reaction mixture via centrifugation at 10,000 rpm for 10 minutes followed by repeated washings with ethanol (95%, V/V). Centrifugation and vortexing procedures were used between the two washing steps. In step II, Cu loaded silica shell was grown on the silica “seed” particles at room temperature. In a typical procedure the “seed” particles were dispersed under magnetic stirring at 400 rpm in 75 μL of 1% hydrochloric acid (Fisher Scientific) followed by addition of 38.6 mg of copper sulfate pentahydrate in 25 mL of DI water. 650 μL of TEOS was added under stirring conditions. The Cu-silica shell growth process was allowed to continue for 24 hrs. The resulting C—S CuSiO₂NPs were then isolated from the reaction mixture and washed thoroughly following the procedure as described above.

### Nanoparticle Characterization

A number of characterization techniques including Scanning Electron Microscopy (SEM; Zeiss ULTRA-55 FEG), Transmission Electron Microscopy (TEM, JEOL JEM-1011), Atomic Force Microscopy (AFM, VEECO Dimensions 3100), Dynamic Light Scattering (DLS, Precision detector PD20000/Coolbatch 40T; equipped with a 30 mW 680 nm diode laser, 90 degree DLS optics, 17 micron fiber-optic cable—single aperture, integrated photon counting module and an auto-correlator) and Atomic Absorption Spectroscopy (AAS, Perkin Elmer AAnalyst 400 AA spectrometer) were used to characterize both the “seed” SiNP and the C—S CuSiO₂NPs.

Sample preparation for SEM and TEM was done by spin coating the nanoparticle solution on silicon wafers and drop casting on carbon coated copper grids respectively. Electron beam intensity of 5 KV was used for SEM and 100 KV for TEM. The aperture size for SEM was 30 microns. For AFM, the nanoparticles solution was spin coated on cover slips to obtain the particle morphology from tapping mode AFM. In this mode of AFM, the cantilever oscillates up and down interacting with the surface and imaging its morphology. For the DLS measurements, approximately 10 μL of the thoroughly washed nanoparticle suspension was diluted in 1 mL of distilled water to measure the hydrodynamic size of the particle.

### Antibacterial Assays

Bacterial growth inhibition test using turbidity and two standard biochemical assays (Resazurin and Baclight assays) were performed to determine antibacterial properties of C—S CuSiO₂NP material against a gram positive Bacillus subtilis (B. subtilis, ATCC 9372) and a gram negative Escherichia coli (E. coli, ATCC 35218) organism. A single colony was inoculated in 10 mL of the broth and grown overnight at 36° C. on a 150 rpm shaker. Subcultures were periodically made on LB agar plates to maintain the organisms. For all antibacterial assays, bacterial concentration of 10⁸ cells/mL was considered. Kocide® 3000 (Cu hydroxide nanoparticles, represented as “insoluble” Cu compound) with same metallic copper concentration was used as positive control and silica nanoparticle (without Cu loading) was used as negative control.

### (i) Bacterial Growth Inhibition in LB Broth Using Turbidity

Two sets (Set1 and Set 2) of different concentrations of C—S CuSiO₂NP were made in LB broth (0.24, 0.49, 1.2, 2.4, 4.9, 7.2 and 9.6 μg metallic Cu equivalent/mL DI water) to a final volume of 10 mL. 10⁸ cells/mL (500 μL) of E. coli and B. subtilis were added to all tubes in Set 1 and Set 2 respectively. Silica (“seed”) nanoparticle (2 mL) was taken as the negative control (without Cu loading). Two different concentrations of Kocide® 3000 (2.4 and 4.9 μg of copper per mL) were considered as the positive control. Since C—S CuSiO₂NP, SiNP and Kocide® 3000 are turbid in nature and can interfere with the optical density reading, the background measurements were subtracted to calculate the final reading. All the tubes were shaken well and incubated at 36° C. on a 150 rpm shaker. After 24 hours, aliquots were taken to measure the optical density at 600 nm

### (ii) Minimum Inhibitory Concentration (MIC) Determination

Standard resazurin assay method was used to determine the MIC of C—S CuSiO₂NPs against E. coli and B. subtilis. A 12 well cell culture plate was labeled. Different concentrations of C—S CuSiO₂NP (1.2-9.6 μg/mL) were added to the wells. Equivalent copper concentrations of Kocide® 3000 were taken as positive control and silica nanoparticle as negative control. The total volume in all wells was made to 1 mL with 0.85% saline. 10⁵ cells/mL (100 μL) of E. coli was added to all the wells. 100 μL of resazurin dye solution (6.75 mg/mL) was then added to all the wells. One well was maintained as control for resazurin (without E. coli and sample) and another well as control for E. coli (without sample but with resazurin). The plate was sealed with parafilm and incubated on a 150 rpm shaker at 36° C. The color change was noted after 24 hours. The same procedure was repeated with B. subtilis to find the MIC of C—S CuSiO₂NP against B. subtilis.

(iii) Bac-Light Assay for Live/Dead Cell Staining

The C—S CuSiO₂NP (4.9 μg/mL) was incubated with 10⁸ cells/mL E. coli and B. subtilis in LB broth to determine cell viability using the BacLight bacterial viability kit L7012. 1 mL SiNP was used as negative control. The samples were incubated in different tubes for 4 hours at 36° C. on 150 rpm shaker. The samples were purified from LB broth and centrifuged at 10,000 rcf (relative centrifugal force) for 10 minutes. The supernatant was discarded and resuspended in 0.85% saline and centrifuged again. The final pellet was resuspended in 0.85% saline. 3 μL of the baclight dye mixture was added per mL of the bacterial sample and incubated at room temperature in dark for 15 minutes. 10 μL of the bacterial suspension was placed on a microscope slide and covered with a microscope cover slip and viewed under a confocal microscope. The dead and live cells were counted using the red (642 nm) and green (535 nm) filters respectively at 40× magnification.

### Results and Discussion

### Nanoparticle Characterization

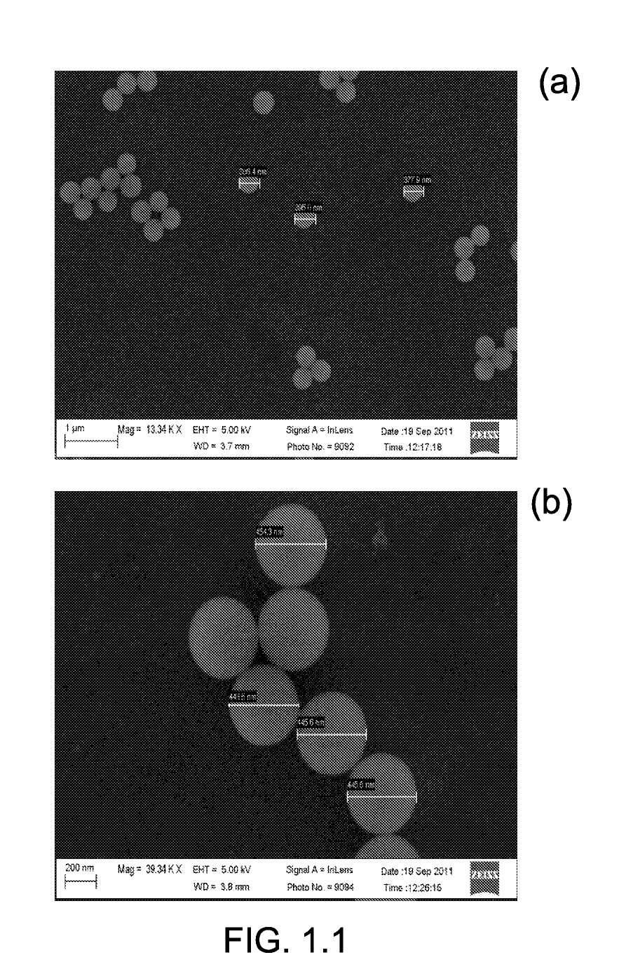

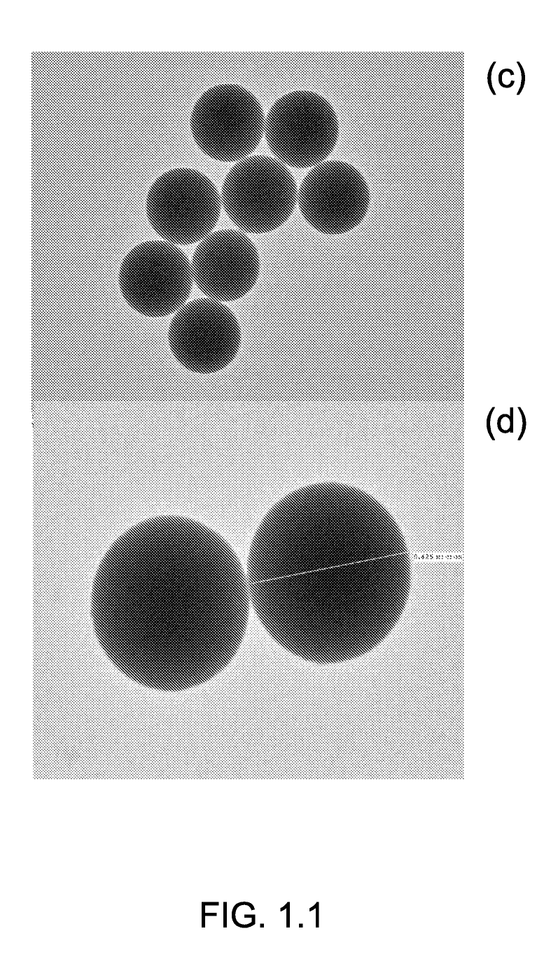

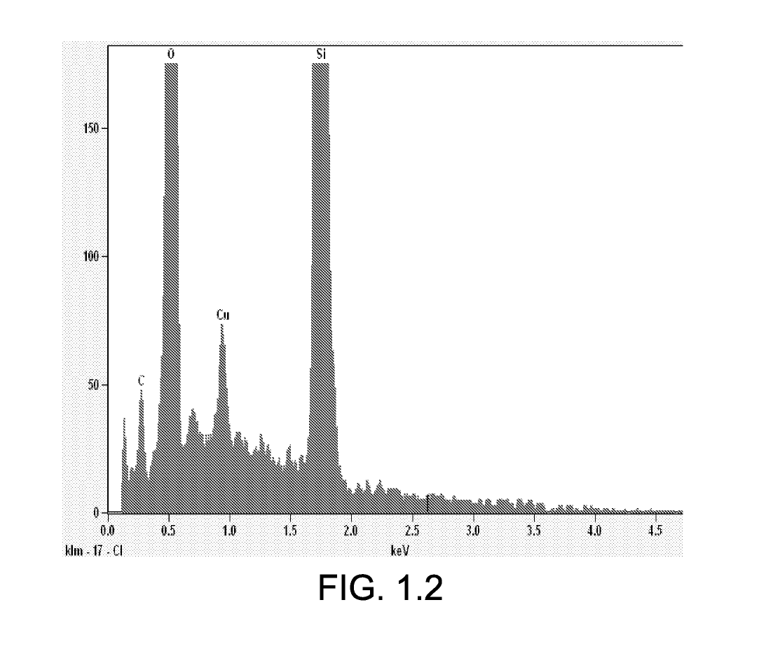

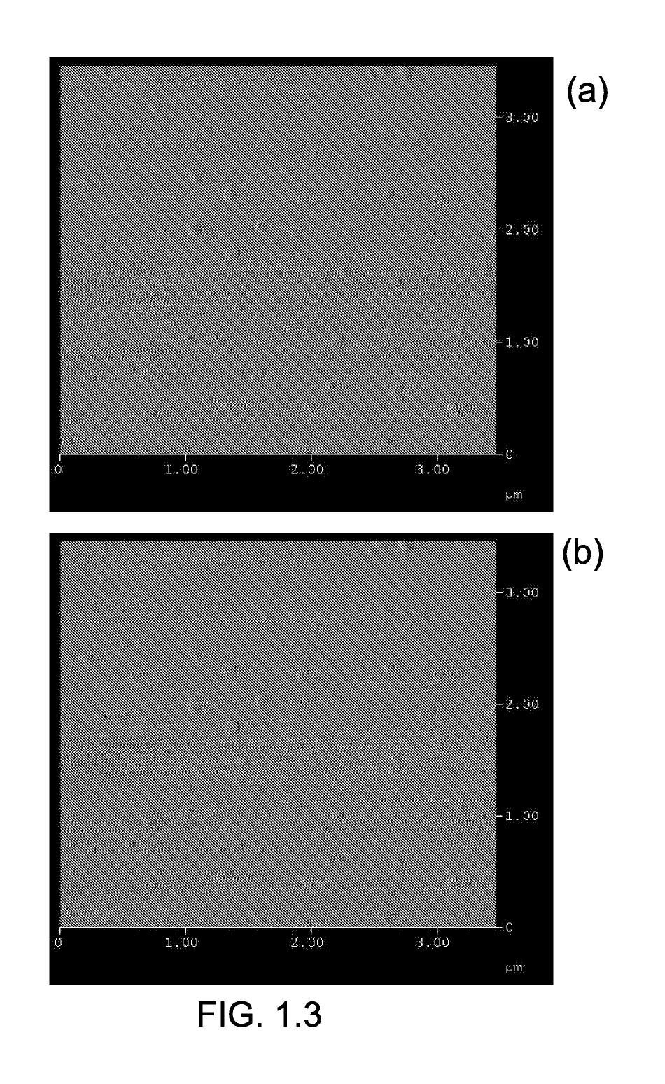

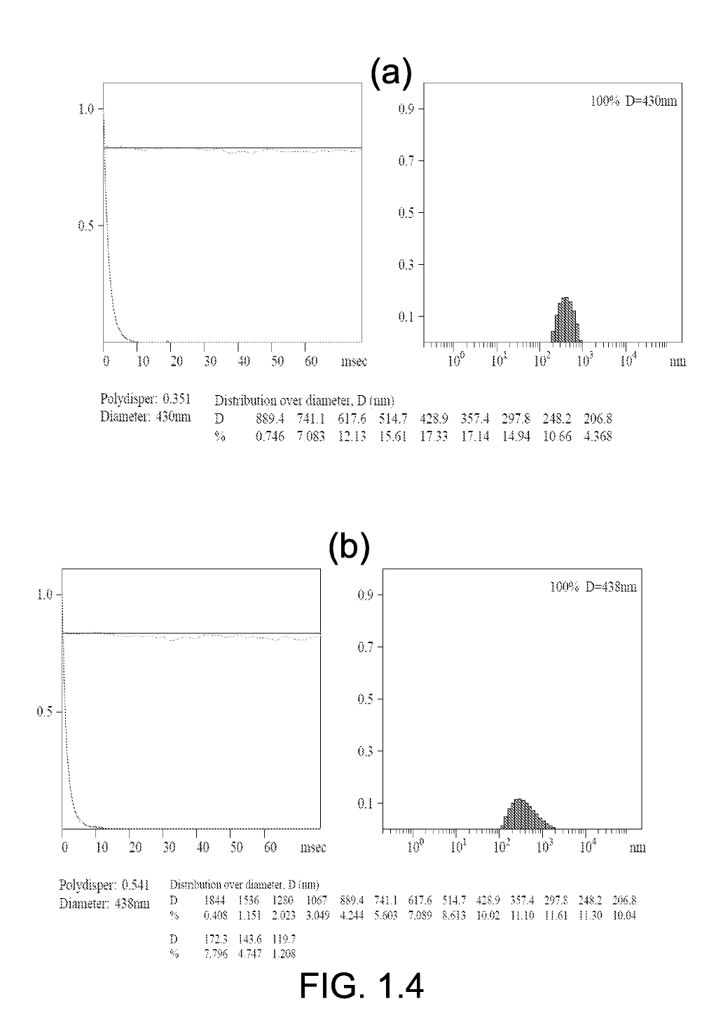

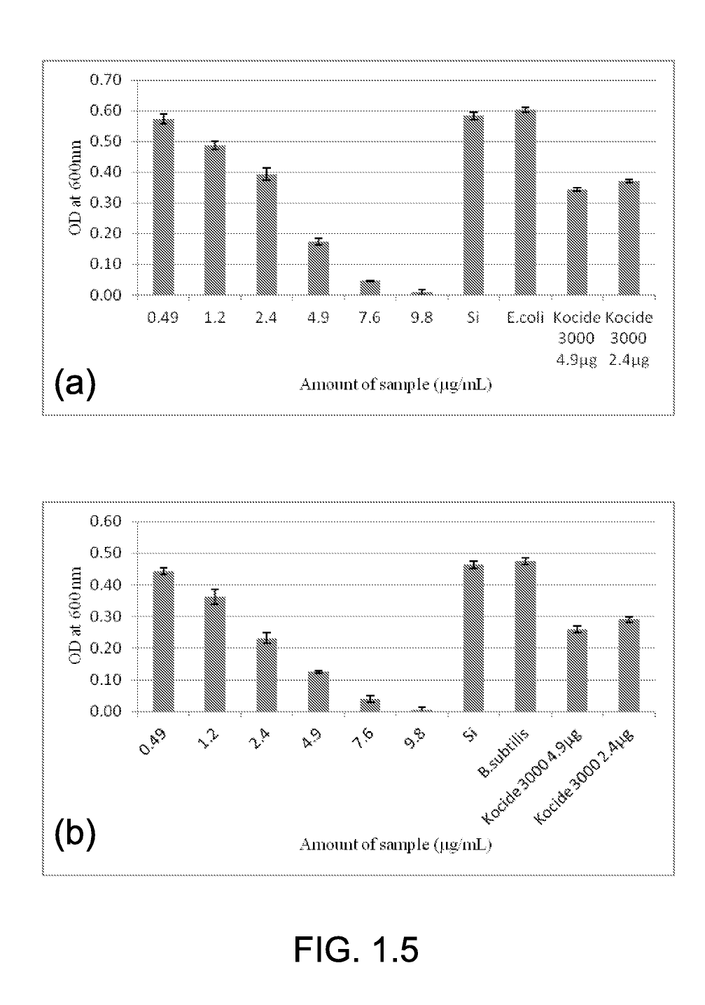

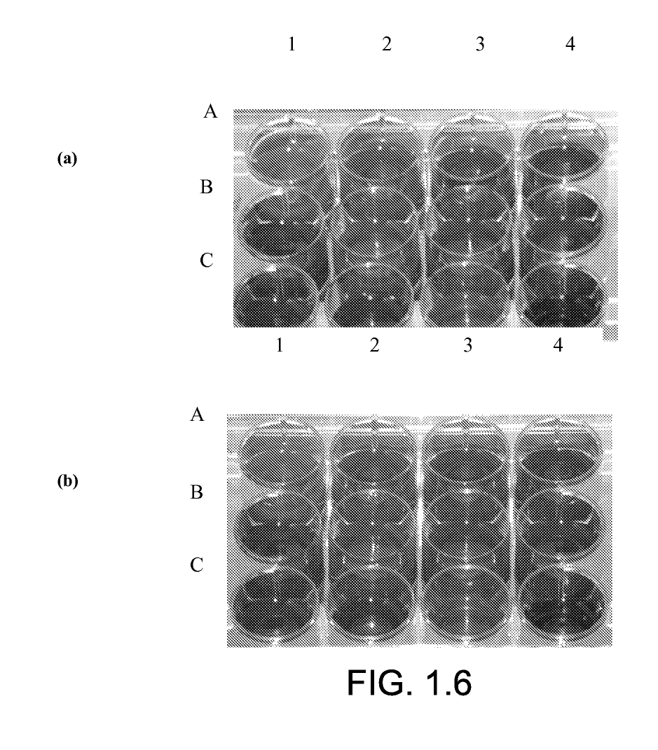

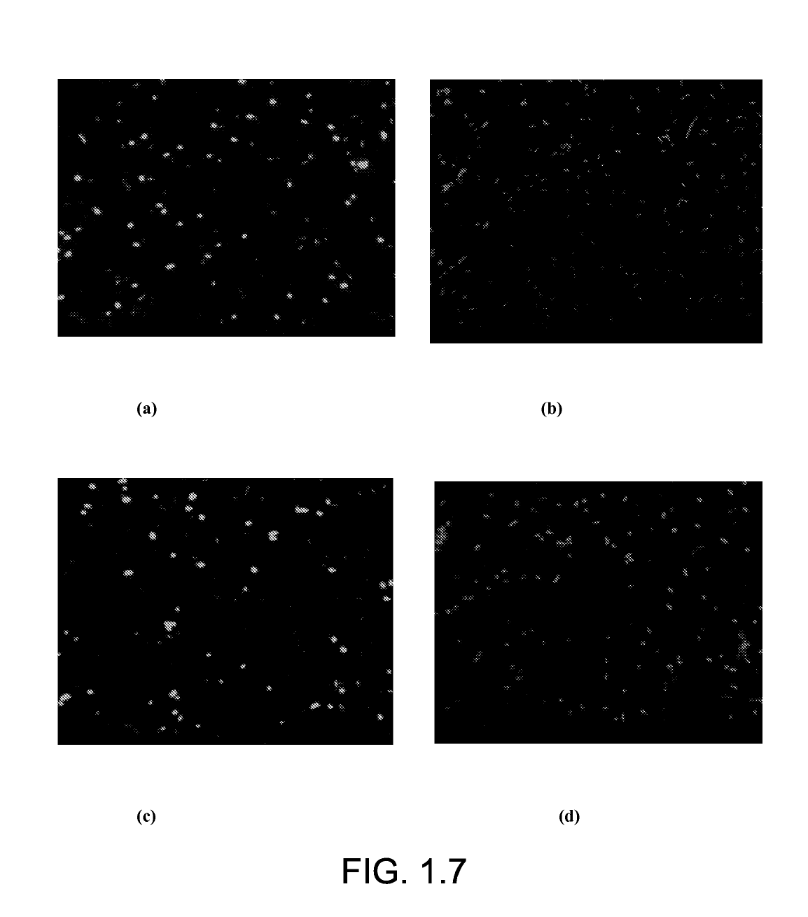

SEM image analysis revealed the formation of highly monodispersed spherical “seed” SiNPs with smooth surface morphology (FIG. 1.1a) with an average particle size of 380 nm. The average particle size of the C—S CuSiO₂NPs was estimated to be 450 nm (FIG. 1.1b). The average particle size was estimated based on the size measurements of approximately 50 particles. An increase in the particle size by ˜35 nm confirms seeded growth of C—S CuSiO₂NPs. A careful investigation of the SEM image revealed that there is no separate nucleation and growth of CuSiO₂NPs (i.e. other than “seeded” growth) confirming the robustness of the synthesis protocol. The surface morphology of the C—S CuSiO₂NPs was very uniform and smooth, suggesting acid-catalyzed fast hydrolysis but slow “seeded” growth process.

TEM images of SiNP and C—S CuSiO₂NP are shown in FIG. 1.1c and 1.1d, respectively. In TEM, differentiation between the shell and the core of the C—S CuSiO₂NPs could not be made because of large particle size (FIG. 1.1d). The entire particle appeared dark. However, the increase in particle size for C—S CuSiO₂NP when compared to SiNP core was consistent with the SEM images. SEM-EDS compositional analysis showed the presence of copper peak in C—S CuSiO₂NP (FIG. 1.2) confirming the presence of copper. Analysis of AFM images (FIG. 1.3a and 1.3b) showed the formation of small and large particles. However, it was difficult to distinguish between individual particles (isolated particle) and particle agglomerates (particle clusters) in the dry state. Particle clusters appeared as large particles.

Particle size and size distribution were measured in solution using DLS technique. DLS estimated the average particle size to be ˜430 for SiNP and ˜438 for C—S CuSiO₂NP (FIG. 1.4a and 1.4b). The difference in particle size in DLS when compared to electron microscopy images could be attributed to the particle-particle interaction in solution. It is observed that particle size distribution of C—S CuSiO₂NPs is relatively broad in comparison to that of SiNPs. This could be attributed to reduction of overall negative silica surface charge due to binding with Cu²⁺ ions.

The amount of copper loading in C—S CuSiO₂NP was quantified by AAS measurements. AAS sample preparation involved extraction of Cu from lyophilized C—S CuSiO₂NP powder using saturated ethylenediaminetetraacetic acid (EDTA) solution. The EDTA leaches out Cu from the C—S CuSiO₂NP material, forming water-soluble Cu-EDTA complex. In comparison with the copper standards, the amount of copper in C—S CuSiO₂NP was found to be 0.098 μg of Cu per mg of C—S CuSiO₂NP material.

### Antibacterial Studies

The growth inhibitory effects of C—S CuSiO₂NP against E. coli and B. subtilis were studied in Luria Bertani (LB) medium (FIG. 1.5a and 1.5b). Bacterial growth at different concentrations of C—S CuSiO₂NP (0.24 to 9.6 μg Ml⁻¹) was evaluated after 24 hours of incubation at 36° C. by measuring the optical density at 600 nm (Teysche800 spectrophotometer). Since the turbidity of C—S CuSiO₂NP can interfere with the optical density reading, the background measurement was subtracted to calculate the final reading. Significant inhibition of bacterial growth against B. subtilis and E. coli was observed due to presence of C—S CuSiO₂NPs in growth medium. Interestingly, B. subtilis was more susceptible to C—S CuSiO₂NPs than E. coli. This difference in susceptibility could be attributed to the difference in cell wall structure and components between the two organisms²⁴. E. coli being a gram-negative organism contains lippopolysaccharide (LPS) making it more virulent when compared to B. subtilis, a gram-positive organism which lacks the LPS. At 4.9 and 2.4 μg mL⁻¹ of metallic copper concentration, C—S CuSiO₂NP exhibited improved antibacterial efficacy than Kocide® 3000 against both E. coli and B. subtilis. Improved antibacterial efficacy of C—S CuSiO₂NP is attributed to increased copper bioavailabilty (i.e. more “soluble” Cu).

Cu hydroxide is a water-insoluble compound (solubility product, Kₛₚ is 2.2×10⁻²⁰) and therefore it will produce less “soluble” Cu when dispersed in water. Less “soluble” Cu means limited Cu bioavailability and hence limited anti-bacterial efficacy. Kocide® 3000 is an ultra-fine (sub-micron size) particulate Cu hydroxide compound. It is therefore expected that due to high surface area to volume ratio, Kocide® 3000 Cu hydroxide will produce more “soluble” Cu than fine (micronized) or bulk Cu hydroxide compound. However, due to inherent water-insolubility, overall Cu bioavailability of Kocide® 3000 Cu hydroxide is expected to be much less than any “soluble” Cu compounds. As a result anti-bacterial efficacy of Kocide® 3000 Cu hydroxide will be limited despite of any further reduction of particle size. In contrast, Cu environment in C—S CuSiO₂NP material is very different than any “insoluble” or “soluble” Cu compounds. Cu (II) ions in C—S CuSiO₂NP are weakly chelated by the silica matrix via silica silanol (Si—OH) groups. The Cu-silica complex remains in equilibrium with the free Cu (II) ions and can be considered as mixture of “soluble” and “insoluble” Cu, thus improving Cu bioavailability over Kocide® 3000 Cu hydroxide.

Minimum Inhibitory Concentration (MIC) of C—S CuSiO₂NP material was determined against E. coli and B. subtilis by resazurin assay⁴⁰. Resazurin assay is a standard cell viability assay based on the oxidation-reduction of resazurin. It is blue in color in its oxidized non-fluorescent form. However, it turns pink and exhibits strong fluorescence when reduced to resofurin by oxidoreductases within the viable cells⁴⁰. The color change was noted after 24 hours (FIG. 1.6a and 1.6b). At concentrations 2.4-9.6 μg mL⁻¹ of C—S CuSiO₂NP, the solution remained purple. However at 1.2 μg mL⁻¹ of C—S CuSiO₂NP, the solution turned pink. This was observed for both the bacterium. Reproducibility of the results was checked by performing experiments in triplicates. Similar results were obtained every time. Hence the MIC value was estimated to be 2.4 μg/mL of C—S CuSiO₂NP for both E. coli and B. subtilis.

Baclight live/dead cell staining⁴¹ was done to determine the cell viability of E. coli and B. subtilis. Images of live/dead cells were taken using a confocal microscope (Zeiss Axioskop 2) (FIG. 1.7). The kit contains two dyes—propidium iodide, the red-fluorescent dye which stains damaged or deformed cells and SYTO®9, the green-fluorescent dye which stains all types of cells. However, propidium iodide is dominant in dead cells giving it the red color. The green filter (535 nm) was used to view live cells and red filter (642 nm) sets for dead cells. It is clear from FIG. 1.7b and 1.7d that treatment of both gram-negative and gram-positive organism with C—S CuSiO₂NP resulted in a 50% increase in red (dead) cells which was obtained as a mean of five images. This confirms the antibacterial activity of copper even for a short incubation time.

### Conclusion

A novel core-shell copper loaded silica nanoparticle (C—S CuSiO₂NP, ˜450 nm) was synthesized, where the Stöber silica serves as the core (“seed” particles, ˜380 nm). Electron microscopy imaging confirms the formation of spherical highly monodispersed nanoparticles with smooth surface morphology. The SEM-EDS characterization confirms the presence of Cu in silica shell surface. Antimicrobial studies show significant growth inhibition against both gram-negative and gram-positive bacteria. Our study indicates that bioavailability of Cu has increased in C—S CuSiO₂NP in comparison to positive control Cu hydroxide, an “insoluble” submicron size Cu compound (Kocide® 3000 fungicide/bactericide from DuPont™ which is widely used in agriculture) due to availability of more “soluble” Cu. Improving efficacy of Cu biocide has clear advantage of reducing undesirable burden related to Cu toxicity in the environment. For example, with improved Cu bioavailability, it is feasible to use the present C—S CuSiO₂NPs in spray-based formulations to spray-coat touch surfaces to generate antimicrobial “touch-safe” surface. Since silica is a biocompatible material carrying only 0.01 wt % metallic Cu, it is expected that the spray formulation containing C—S CuSiO₂NPs could be considered as environment-friendly.

References, each of which is incorporated herein by reference
1. G. Borkow, J. Gabbay, Copper as a biocidal tool Current Medicinal Chemistry 12, 2163-2175 (2005).
2. V. A. Gant, M. W. D. Wren, M. S. M. Rollins, A. Jeanes, S. S. Hickok, T. J. Hall, Three novel highly charged copper-based biocides: safety and efficacy against healthcare-associated organisms Journal of Antimicrobial Chemotherapy 60, 294-299 (2007).
3. T. J. Hall, A. Jeanes, P. G. Coen, A. Odunaike, S. S. Hickok, V. A. Gant, A hospital cleaning study using microfibre and a novel copper biocide. I. Microbiological studies Journal of Infection Prevention 12, 188-194 (2011).
4. G. Grass, C. Rensing, M. Solioz, Metallic Copper as an Antimicrobial Surface Applied and Environmental Microbiology 77, 1541-1547 (2011).
5. C. E. Santo, E. W. Lam, C. G. Elowsky, D. Quaranta, D. W. Domaille, C. J. Chang, G. Grass, Bacterial Killing by Dry Metallic Copper Surfaces Applied and Environmental Microbiology 77, 794-802 (2011).
6. P. Appendini, J. H. Hotchkiss, Review of antimicrobial food packaging Innovative Food Science &amp; Emerging Technologies 3, 113-126 (2002).
7. M. H. Freeman, C. R. McIntyre, A Comprehensive Review of Copper-Based Wood Preservatives Forest Products Journal 58, 6-27 (2008).
8. T. P. Schultz, D. D. Nicholas, A. F. Preston, Perspective—A brief review of the past, present and future of wood preservation Pest Management Science 63, 784-788 (2007).
9. A. Singh, V. Krishna, A. Angerhofer, B. Do, G. MacDonald, B. Moudgil, Copper Coated Silica Nanoparticles for Odor Removal Langmuir 26, 15837-15844 (2010).
10. N. Voulvoulis, M. D. Scrimshaw, J. N. Lester, Alternative antifouling biocides Applied Organometallic Chemistry 13, 135-143 (1999).
11. A. Mikolay, S. Huggett, L. Tikana, G. Grass, J. Braun, D. H. Nies, Survival of bacteria on metallic copper surfaces in a hospital trial Applied Microbiology and Biotechnology 87, 1875-1879 (2010).
12. A. L. Casey, D. Adams, T. J. Karpanen, P. A. Lambert, B. D. Cookson, P. Nightingale, L. Miruszenko, R. Shillam, P. Christian, T. S. J. Elliott, Role of copper in reducing hospital environment contamination Journal of Hospital Infection 74, 72-77 (2010).
13. V. A. Luna, T. J. Hall, D. S. King, A. C. Cannons, Susceptibility of 169 USA300 methicillin-resistant Staphylococcus aureus isolates to two copper-based biocides, CuAL42 and CuWB50 Journal of Antimicrobial Chemotherapy 65, 939-941 (2010).
14. L. Weaver, J. O, Noyce, H. T. Michels, C. W. Keevil, Potential action of copper surfaces on meticillin-resistant Staphylococcus aureus Journal of Applied Microbiology 109, 2200-2205 (2010).
15. M. Pavlovic, A REVIEW OF AGRIBUSINESS COPPER USE EFFECTS ON ENVIRONMENT Bulgarian Journal of Agricultural Science 17, 491-500 (2011).
16. F. Behlau, J. Belasque, Jr., A. Bergamin Filho, J. H. Graham, R. P. Leite, Jr., T. R. Gottwald, Copper sprays and windbreaks for control of citrus canker on young orange trees in southern Brazil Crop Protection 27, 807-813 (2008).
17. F. Behlau, J. Belasque, Jr., J. H. Graham, R. P. Leite, Jr., Effect of frequency of copper applications on control of citrus canker and the yield of young bearing sweet orange trees Crop Protection 29, 300-305 (2010).
18. K. A. Dafform, J. A. Lewis, E. L. Johnston, Antifouling strategies: History and regulation, ecological impacts and mitigation Marine Pollution Bulletin 62, 453-465 (2011).
19.1. K. Konstantinou, T. A. Albanis, Worldwide occurrence and effects of antifouling paint booster biocides in the aquatic environment: a review Environment International 30, 235-248 (2004).
20. A. Terlizzi, S. Fraschetti, P. Gianguzza, M. Faimali, F. Boero, Environmental impact of antifouling technologies: state of the art and perspectives Aquatic Conservation-Marine and Freshwater Ecosystems 11, 311-317 (2001).
21. K. V. Thomas, S. Brooks, The environmental fate and effects of antifouling paint biocides Biofouling 26, 73-88 (2010).
22. C. A. Flemming, J. T. Trevors, Copper toxicity and chemistry in the environment: a review Water, Air, & Soil Pollution 44, 143-158 (1989).
23. G. Gu, J. Xu, Y. Wu, M. Chen, L. Wu, Synthesis and antibacterial property of hollow SiO(2)/Ag nanocomposite spheres Journal of Colloid and Interface Science 359, 327-333 (2011).
24. K. Nischala, T. N. Rao, N. Hebalkar, Silica-silver core-shell particles for antibacterial textile application Colloids and Surfaces B-Biointerfaces 82, 203-208 (2011).
25. K. Xu, J.-X. Wang, X.-L. Kang, J.-F. Chen, Fabrication of antibacterial monodispersed Ag—SiO(2) core-shell nanoparticles with high concentration Materials Letters 63, 31-33 (2009).
26. Y. Le, P. Hou, J. Wang, J.-F. Chen, Controlled release active antimicrobial corrosion coatings with Ag/SiO(2) core-shell nanoparticles Materials Chemistry and Physics 120, 351-355 (2010).
27. J. Zhai, X. Tao, Y. Pu, X.-F. Zeng, J.-F. Chen, Core/shell structured ZnO/SiO(2) nanoparticles: Preparation, characterization and photocatalytic property Applied Surface Science 257, 393-397 (2010).
28. N. Y. Hebalkar, S. Acharya, T. N. Rao, Preparation of bi-functional silica particles for antibacterial and self cleaning surfaces Journal of Colloid and Interface Science 364, 24-30 (2011).
29. K. Cendrowski, X. Chen, B. Zielinska, R. J. Kalenczuk, M. H. Ruemmeli, B. Buechner, R. Klingeler, E. Borowiak-Palen, Synthesis, characterization, and photocatalytic properties of core/shell mesoporous silica nanospheres supporting nanocrystalline titania Journal of Nanoparticle Research 13, 5899-5908 (2011).
30. S. Kamaruddin, D. Stephan, The preparation of silica-titania core-shell particles and their impact as an alternative material to pure nano-titania photocatalysts Catalysis Today 161, 53-58 (2011).
31. Y. Zhang, L. Yu, S. Ke, B. Shen, X. Meng, H. Huang, F. Lv, J. H. Xin, H. L. W. Chan, TiO(2)/SiO(2) hybrid nanomaterials: synthesis and variable UV-blocking properties Journal of Sol-Gel Science and Technology 58, 326-329 (2011).
32. K. Chatterjee, D. Das, D. Chakravorty, Optical absorption in composites containing copper core-copper-oxide shell nanostructure in a silica gel Journal of Physics D-Applied Physics 38, 451-455 (2005).
33. Z. Nan, N. Liu, C. Wei, A facile method to synthesize novel monodisperse core-shell structure of spherical silica at nanocrystalline copper Materials Science & Engineering C-Biomimetic and Supramolecular Systems 29, 1124-1127 (2009).
34. B. Sreedhar, P. Radhika, B. Neelima, N. Hebalkar, Synthesis and characterization of silica@copper core-shell nanoparticles: Application for conjugate addition reactions Chemistry-an Asian Journal 3, 1163-1169 (2008).
35. L. Armelao, D. Barreca, G. Bottaro, G. Mattei, C. Sada, E. Tondello, Copper-Silica Nanocomposites Tailored by the Sol-Gel Route Chemistry of Materials 17, 1450-1456 (2005).
36. J. L. Mohanan, S. L. Brock, Influence of Synthetic and Processing Parameters on the Surface Area, Speciation, and Particle Formation in Copper Oxide/Silica Aerogel Composites Chemistry of Materials 15, 2567-2576 (2003).
37. G. De, Sol-Gel Synthesis of Metal Nanoclusters-Silica Composite Films Journal of Sol-Gel Science and Technology 11, 289-298 (1998).
38. Y. H. Kim, D. K. Lee, H. G. Cha, C. W. Kim, Y. C. Kang, Y. S. Kang, Preparation and Characterization of the Antibacterial Cu Nanoparticle Formed on the Surface of SiO2 Nanoparticles The Journal of Physical Chemistry B 110, 24923-24928 (2006).
39. L. M. Rossi, L. F. Shi, F. H. Quina, Z. Rosenzweig, Stöber synthesis of monodispersed luminescent silica nanoparticles for bioanalytical assays Langmuir 21, 4277-4280 (2005).
40. S. D. Sarker, L. Nahar, Y. Kumarasamy, Microtitre plate-based antibacterial assay incorporating resazurin as an indicator of cell growth, and its application in the in vitro antibacterial screening of phytochemicals Methods 42, 321-324 (2007).
41. S. K. Rastogi, V. J. Rutledge, C. Gibson, D. A. Newcombe, J. R. Branen, A. L. Branen, Ag colloids and Ag clusters over EDAPTMS-coated silica nanoparticles: synthesis, characterization, and antibacterial activity against Escherichia coli Nanomedicine: Nanotechnology, Biology and Medicine 7, 305-314 (2011).

### Example 2

### Brief Introduction

Antimicrobial properties of copper (Cu) and silver (Ag) ions have been widely studied. Hundreds of nanotech based consumer products are now available in the market which uses antimicrobial Ag nanoparticles. Cu and Cu alloy based touch surfaces are shown to be effective in controlling bacterial infection. In this example, we will present our research on synthesis and characterization of sol-gel silica nanoparticle/nanogel materials loaded with antimicrobial Cu and Ag. Structure/morphology and antimicrobial properties of the silica nanoparticle/nanogel delivery system with and without containing the active agent (Cu or Ag) will be discussed. We have tested antimicrobial properties of these materials against both gram-negative (E. Coli) and gram-positive (B. Subtilis) bacteria. Our results on Cu nanomaterials showed improved antibacterial efficacy of Cu loaded silica nanomaterial over its Cu source while the concentration of metallic Cu remained the same. Several materials characterization techniques were used to understand structure-property relationship using Cu loaded silica nanoparticle/nanogel nanomaterial.

### Introduction:

Metallic nanoparticles have been used recently for a wide range of biomedical applications^{1, 2}. Silver and copper have been known for ages for its antimicrobial properties. Copper and silver are being used as antifouling, antifungal agents for many industrial applications. Their antibacterial property finds wide usage in many health-care facilities to create microorganism free environment. Various techniques are being used for synthesis of metallic nanoparticles. They include inert gas condensation technique, electrolysis method, deposition of metallic salts on the matrix, reduction of metallic salt³⁻⁷. This paper is focused on the synthesis, characterization and antibacterial properties of silica-silver nanogel and silica-copper nanoparticles by acid and base hydrolysis respectively. Silver embedded silica nanogel is synthesized using simple water based sol-gel technology. In this method the simultaneous hydrolysis and condensation of silica facilitates the reduction of silver ions to form silver nanoparticles entrapped in silica gel matrix⁸. Copper nanoparticles are synthesized based on a novel core-shell design, where the silica nanoparticle serves as the ‘core’ and copper grows as the ‘shell’ around the core⁹.

### Experimental

All reagents were purchased from commercial vendors and used without any further purification. Bacterial strains were provided by Ishrath Sharma, Microbiology department, University of Central Florida.

### Nanomaterial Synthesis

The core-shell copper loaded silica nanoparticles (C—S CuSiNP) were synthesized in a two-step fashion as discussed in our previous work⁹. The first step involved the synthesis of ‘seed’ silica nanoparticles based on a published protocol¹⁰. Tetraethylorthosilicate (TEOS, a silane precursor; Fisher Scientific) was added to a solution of 95% ethanol (Fisher Scientific), ammonium hydroxide (Fisher Scientific) and water (nanopure deionized) under stirring conditions. The contents were left on a 400 rpm magnetic stirrer for 1 hour. This was followed by sonication for 10 minutes. The silica nanoparticles (SiNP) were purified by washing (centrifuging) the particles with 95% ethanol at 10,000 rpm for 10 minutes to remove ammonium hydroxide. The final wash (10,000 rpm, 10 minutes) was done with water. The second step involved the growth of copper shell around the silica nanoparticle core. The silica ‘seed’ particles were dispersed in acidic pH water followed by addition of copper sulfate pentahydrate (CQ concepts, Ringwood, Ill.) and TEOS under magnetic stirring conditions. The growth of the copper ‘shell’ around the silica nanoparticle ‘core’ was allowed to grow for 24 hours. The particles were then isolated by washing (centrifugation) with water twice at 10,000 rpm for 10 minutes to remove excess copper.

The synthesis of silver loaded silica nanogel (AgSiNG) was carried on using sol-gel method in water and acidic condition in one step¹¹. This procedure was similar to the second step of C—S CuSiNP synthesis as described in the above section. Silver nitrate salt (Acros organics) was used as the source of Ag and 1% Nitric acid (Macron) solution was used for the acid catalyzed hydrolysis of TEOS. Silica nanogel (SiNG) was prepared similarly (without silver nitrate) which was used as control. No further purifications were made to AgSiNG and SiNG materials except that the pH was adjusted to 7.0 using dilute sodium hydroxide solution. A pale yellow coloration was observed for the AgSiNG material.

### Nanomaterial Characterization

Zeiss ULTRA-55 FEG Scanning electron microscopy (SEM) was done to estimate the particle size and morphology of C—S CuSiNP. Spin coating technique was used to prepare the SEM sample on a silicon wafer. The amount of copper in C—S CuSiNP was quantified by Atomic Absorption Spectroscopy (AAS, Perkin Elmer AAnalyst 400 AA spectrometer). The metallic silver content in AgSiNG was quantified from the amount of silver nitrate added in the formulation. The AgSiNG formulation was completely transparent and the material could not be centrifuged down from the solution even at 10,000 rpm. Therefore the AgSiNG formulation was used for antimicrobial studies without any further purification. High-resolution transmission electron microscopy (HRTEM, Technai) technique was used to analyze AgSiNG material for the formation of silver nanoparticles. Sample was prepared by placing a drop of AgSiNG on a carbon coated copper grid.

### Antibacterial Assays

Antibacterial properties of C—S CuSiNP and AgSiNG materials were evaluated against a gram positive Bacillus subtilis (B. subtilis, ATCC 9372) and a gram negative Escherichia coli (E. coli, ATCC 35218) organism. For all antibacterial assays, bacterial concentration of 10⁵ cells/mL was considered. Copper sulfate with same metallic copper concentration was used as positive controls and silica nanoparticle (without Cu loading) was used as negative control. In case of AgSiNG, silver nitrate with similar metallic silver concentration was used as positive control and silica gel (without silver) was used as negative control.

### (I) Bacterial Growth Inhibition in LB Broth Using Turbidity

Two sets of different concentrations of C—S CuSiNP were made in LB broth (0.49, 1.2, 2.4, 4.9, 7.2 and 9.8 ppm copper concentration) to a final volume of 10 mL. 250 μL (10⁵ cells/mL) of E. coli and B. subtilis were added to set 1 and 2 respectively. Silica nanoparticle was used as negative control and copper sulfate with equivalent amount of copper was used as positive control. All the tubes were incubated at 37° C. on a shaker at 150 rpm for 24 hours. Aliquots were taken after 24 hours to measure optical density at 600 nm. The same was repeated for AgSiNG.

### (Ii) Bac-Light Assay for Live/Dead Cell Staining

A known concentration of C—S CuSiNP and AgSiNP with appropriate controls was incubated with E. coli and B. subtilis in LB broth (10⁵ cells/mL) to determine cell viability using the BacLight bacterial viability kit L7012¹². The samples were incubated for 4 hours at 37° C. on 150 rpm shaker. The samples were then centrifuged at 10,000×g for 10 minutes. The supernatant was discarded and resuspended in 0.85% saline and centrifuged again. The final pellet was resuspended in 0.85% saline. 3 μL of the baclight dye mixture was added to all tubes and incubated at room temperature in dark for 15 minutes. 5 μL of the bacterial suspension was trapped between a slide and coverslip and viewed under a fluorescence microscope. The dead and live cells are counted using the red and green filters respectively.

### Results and Discussion

### Nanomaterial Characterization

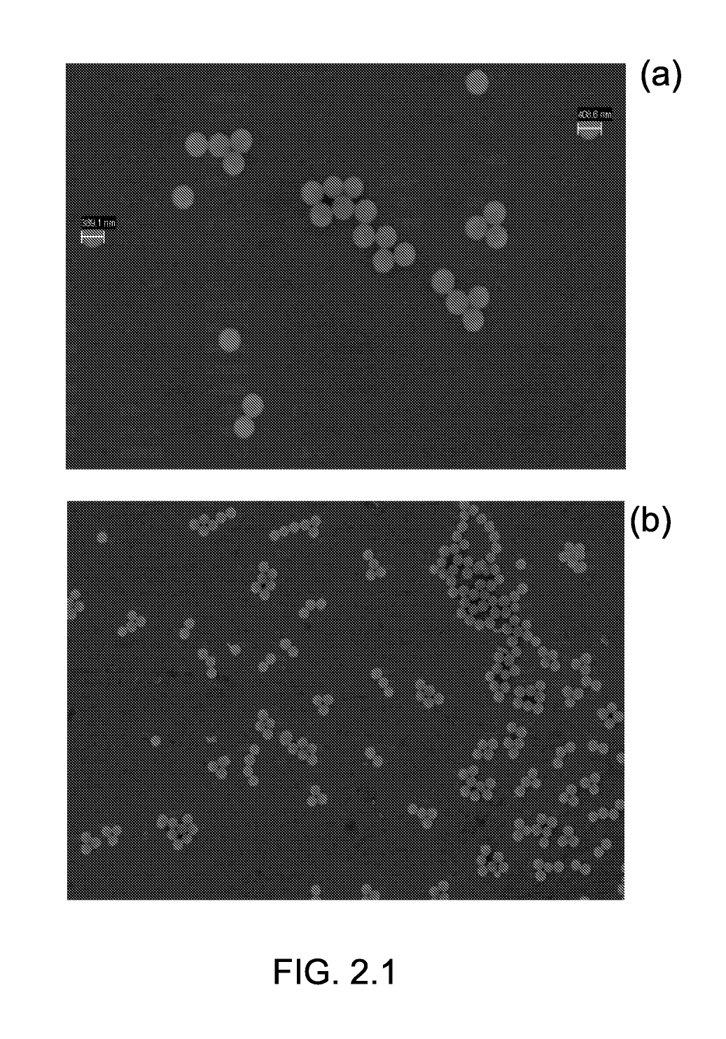

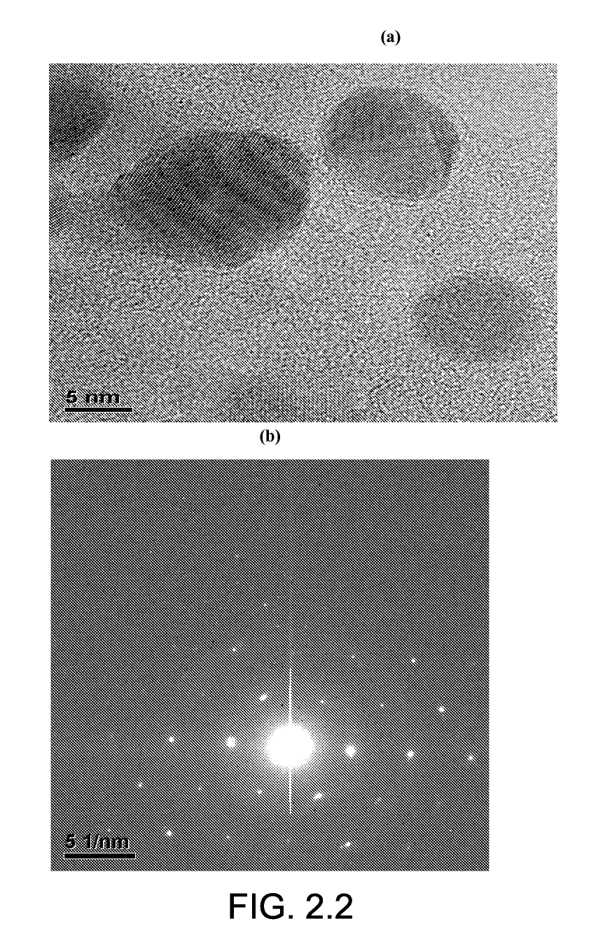

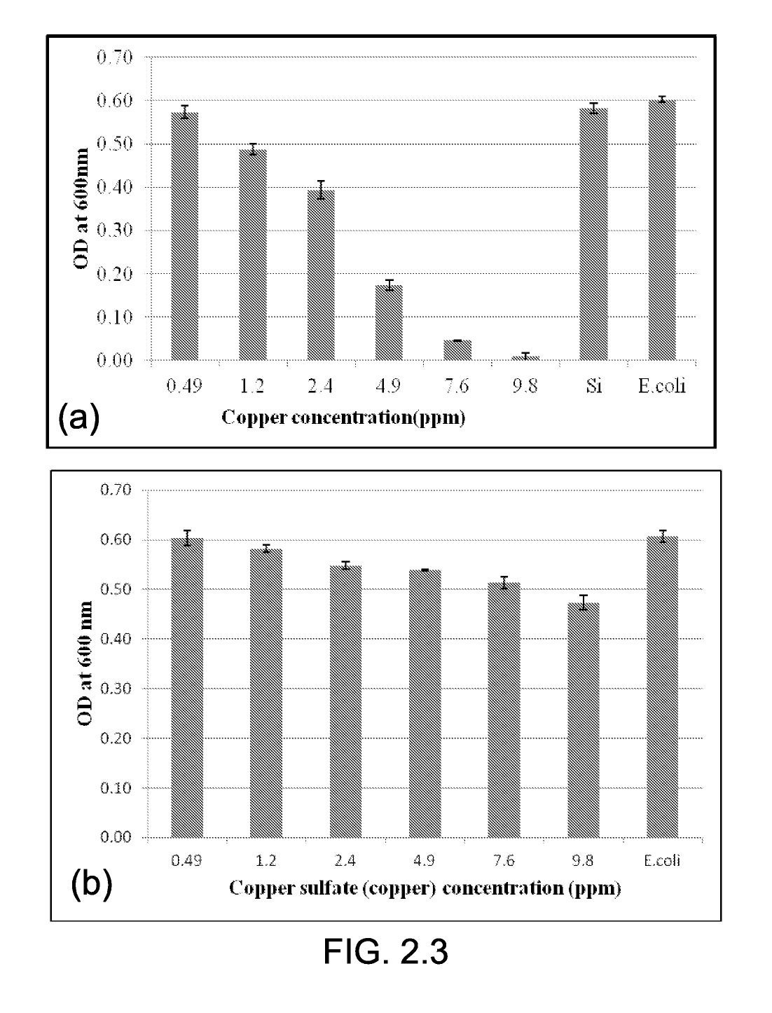

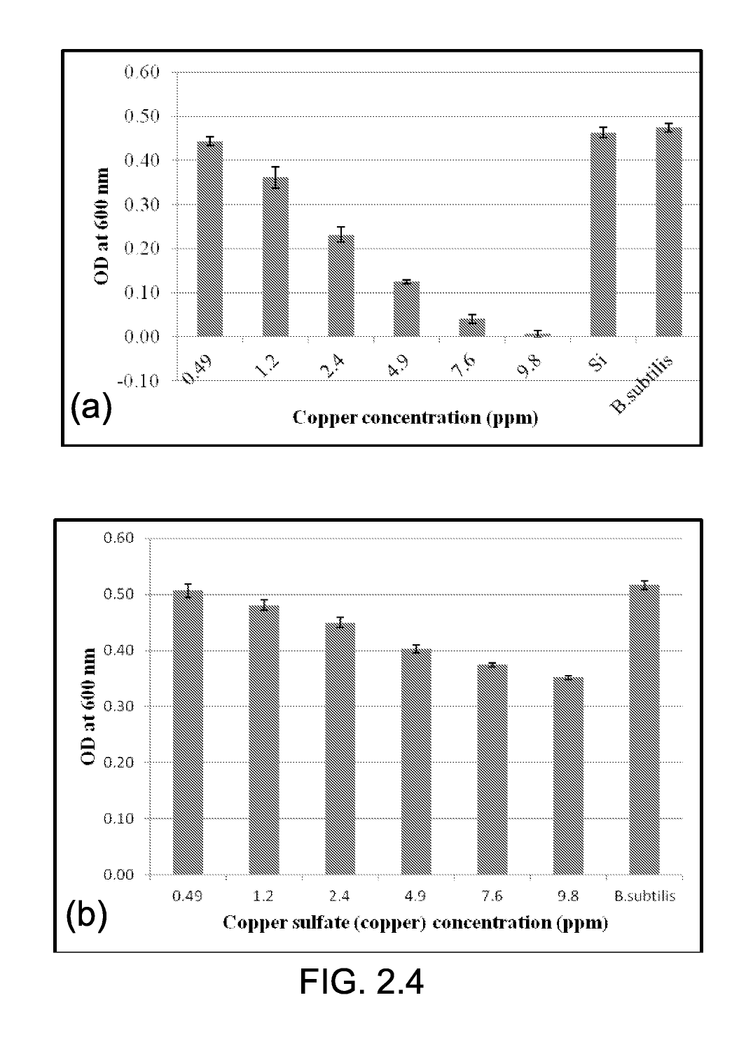

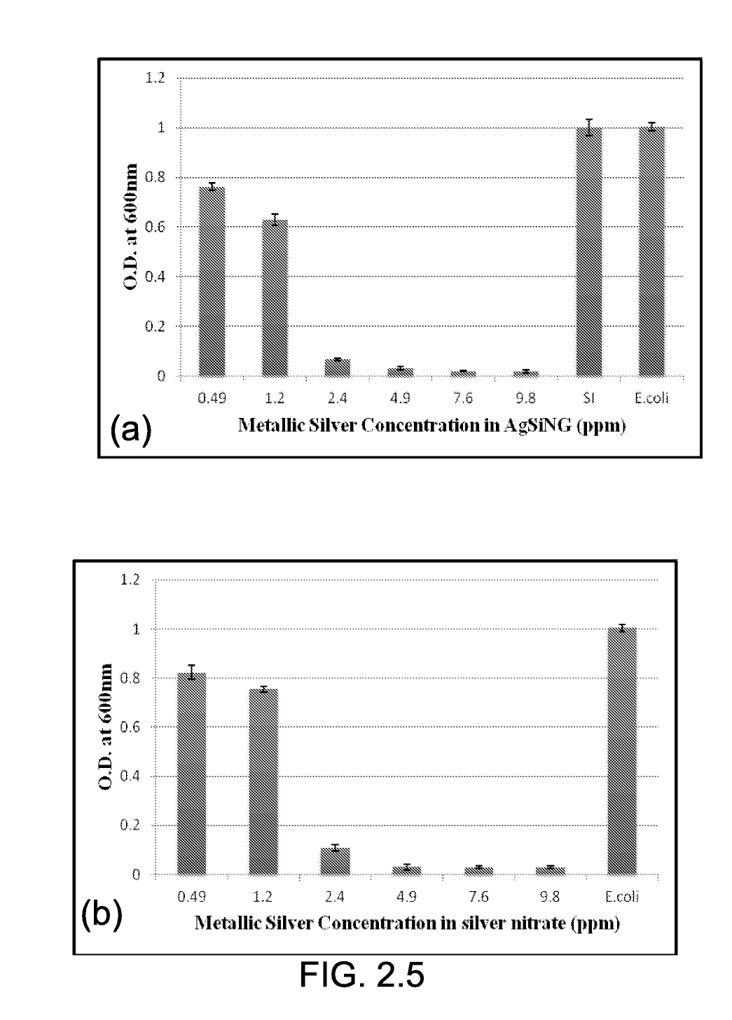

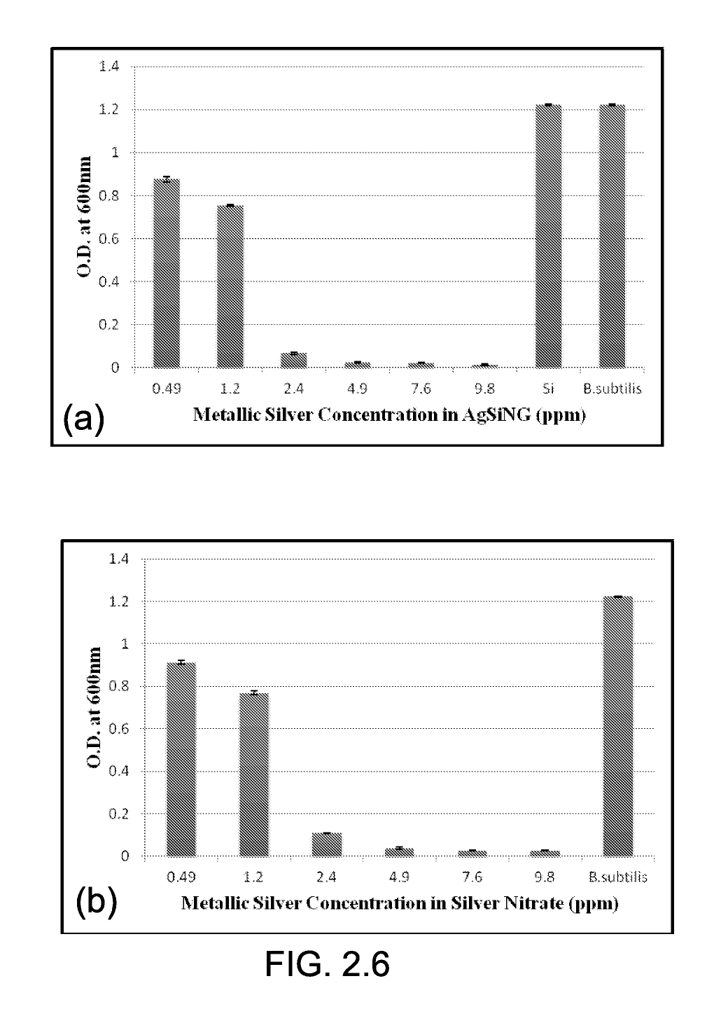

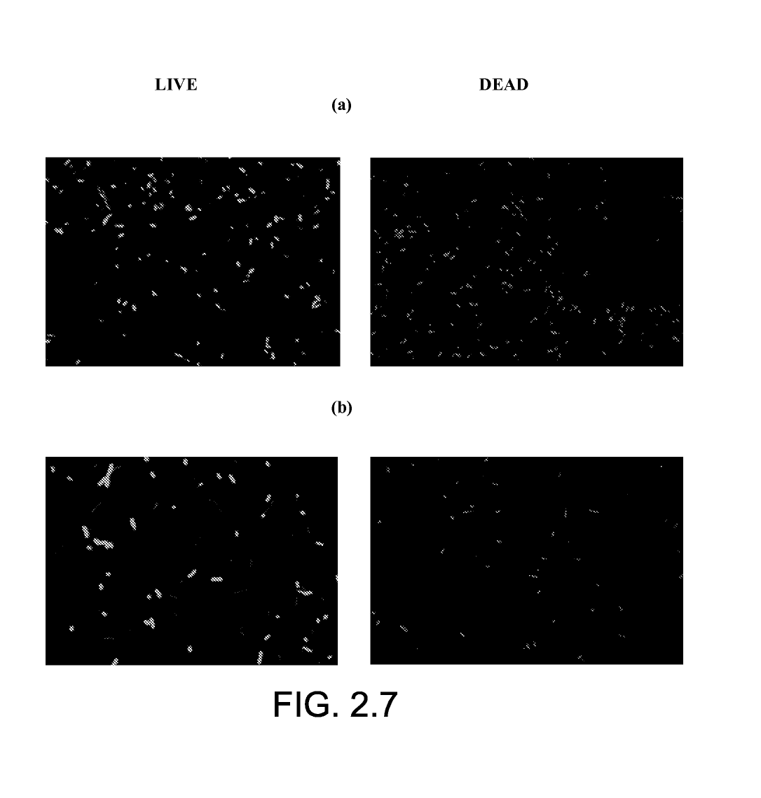

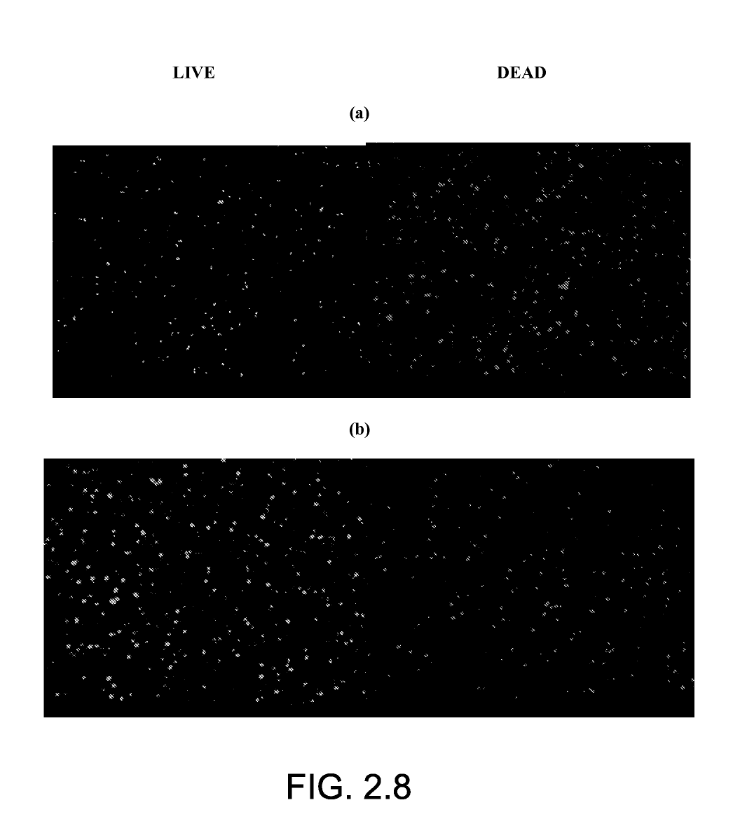

The SEM images of the ‘core’ SiNP (an average particle size of ˜380 nm) and the C—S CuSiNP (an average particle size of ˜450 nm) are shown in FIG. 2.1a and FIG. 2.1b, respectively. The increase in particle size and spherical morphology for C—S CuSiNP confirms uniform growth of copper loaded shell on the silica nanoparticle core with a shell thickness of ˜50 nm. Copper in C—S CuSiNP is chelated by the silica silanol (Si—OH) groups in the silica matrix forming a weak Cu—Si complex. However, the reduction mechanism of copper is not well understood as no specific reducing agent was added externally during the synthesis process. However, it is possible that ethanol (which is produced after the TEOS hydrolysis) and silica (with —OH and —O⁻ groups) might have played a role of mild reducing agents. Atomic Absorption Spectroscopy (AAS) quantified the amount of copper to be 0.098 ppm in comparison to copper standards. FIG. 2.2a shows the HRTEM micrograph of AgSiNG. The formation of silver nanoparticles ranging from 10-20 nm uniformly distributed in amorphous silica matrix (grey material in contrast) was confirmed by the HRTEM. The HRTEM-selected area electron diffraction pattern confirms crystallinity of the silver nanoparticles along with lattice planes of 2.36±0.05 Å for 111 and 2.04±0.04 for 200 specific for Ag. Additionally we also identified 220 and 311 reflections in electron diffraction pattern that are specific for Ag crystals (FIG. 2.2b). The formation of Ag nanoparticles can be accounted to addition of sodium hydroxide in the formulation that acted as a reducing agent¹³ to reduce Ag⁺ to Ag⁰ leading addition of metallic Ag to produce Ag nanoparticles.

### Antibacterial Assays

The growth inhibitory effects of C—S CuSiNP and AgSiNG against E. coli and B. subtilis were studied in liquid media (FIG. 2.3 and FIG. 2.4). Bacterial growth with different concentrations of C—S CuSiNP and AgSiNG (0.49 to 9.8 μg mL⁻¹) was monitored after 24 hours of incubation at 37° C. by measuring the optical density at 600 nm using Teysche800 spectrophotometer. Since the turbidity of silica based material can interfere with the optical density reading, the background measurement was subtracted to calculate the final reading.

C—S CuSiNP showed significant growth inhibition of two different strains of bacterium, gram-negative E. coli and gram-positive B. subtilis. Total inhibition was obtained at 9.8 ppm copper concentration for both the bacterium. C—S CuSiNP exhibited improved antibacterial efficacy in comparison to copper sulfate against E. coli as well as B. subtilis. This clearly shows that C—S CuSiNP has improved copper bioavailability when compared to copper sulfate with similar copper concentration. This could be attributed to the novel core-shell design, where majority of the copper is present in the shell. C—S CuSiNP is intermediate between “soluble” and “insoluble” copper compounds where the Cu ions are chelated in the silica matrix. This results in improved and sustained antibacterial activity in comparison to “soluble” copper sulfate.

In case of AgSiNG higher growth inhibition could be seen in E. coli (FIG. 2.5) than compared to B. subtilis (FIG. 2.6), this could be attributed to the difference in the cell wall structure of the bacteria. No statistically significant difference in the antibacterial efficacy was observed between the AgSiNG and the silver nitrate materials, suggesting that silica matrix served as a host matrix and did not compromise the antibacterial properties of silver. The growth inhibition can be seen at 2.4 ppm of silver in both AgSiNG and silver nitrate solutions. This corresponds to the value of MIC of silver¹⁴. Thus it can be seen that embedding silver in silica did not interrupt the antibacterial properties of silver ions.

Baclight live/dead cell staining was also done using ZEISS Axioskop2 confocal microscope to determine the cell viability of E. coli and B. subtilis. The images of live/dead cells with different concentrations of C—S CuSiNP were taken using a florescent microscope (FIG. 2.7). Similarly images were taken for the bacteria incubated with different concentrations of AgSiNG using fluorescent microscope (FIG. 2.8). The green filter (535 nm) was used to view live cells and red filter (642 nm) was used to view dead cells. The amount of red cells was significantly greater than the green cells, confirming the bactericidal effect of the metallic based silica nanogel nanoparticle material.

### Conclusion

Using a simple sol-gel method, core-shell copper loaded silica nanoparticle (C—S CuSiNP, ˜450 nm) and silver loaded silica nanogel materials embedding 10-20 nm size crystalline silver nanoparticles have been successfully synthesized. In comparison to copper sulfate control, C—S CuSiNP material showed improved antibacterial properties against both E. coli (a gram-negative) and B. subtilis (a gram-positive) bacteria. This has been attributed to improved Cu bioavailability of C—S CuSiNP material where the core-shell design could have been played an important role. Antibacterial efficacy of silver did not compromise in AgSiNG material, suggesting that silica matrix served simply as a host material. The present study demonstrates that the silica matrix can be efficiently used as an inert delivery vehicle for metal based antibacterial active agents such as copper and silver as both nanoparticle and nanogel matrix formats.

References, each of which is incorporated herein by reference
1. G. Borkow, J. Gabbay, Copper as a biocidal tool Current Medicinal Chemistry 12, 2163-2175 (2005).
2. Y. Kobayashi, T. Sakuraba, Silica-coating of metallic copper nanoparticles in aqueous solution Colloids and Surfaces A: Physicochemical and Engineering Aspects 317, 756-759 (2008).
3. P. Appendini, J. H. Hotchkiss, Review of antimicrobial food packaging Innovative Food Science &amp; Emerging Technologies 3, 113-126 (2002).
4. M. H. Freeman, C. R. McIntyre, A comprehensive review of copper-based wood preservatives: with a focus on new micronized or dispersed copper systems Forest Products Journal 58, 6-27 (2008).
5. T. P. Schultz, D. D. Nicholas, A. F. Preston, A brief review of the past, present and future of wood preservation Pest Manage. Sci. 63, 784-788 (2007).
6. A. Singh, V. Krishna, A. Angerhofer, B. Do, G. MacDonald, B. Moudgil, Copper Coated Silica Nanoparticles for Odor Removal Langmuir 26, 15837-15844 (2010).
7. N. Voulvoulis, M. D. Scrimshaw, J. N. Lester, Alternative antifouling biocides Applied Organometallic Chemistry 13, 135-143 (1999).
8. D. V. Quang, P. B. Sarawade, A. Hilonga, J.-K. Kim, Y. G. Chai, S. H. Kim, J.-Y. Ryu, H. T. Kim, Preparation of silver nanoparticle containing silica micro beads and investigation of their antibacterial activity Applied Surface Science 257, 6963-6970 (2011).
9. P. Maniprasad, S. Santra, Novel copper (Cu) loaded core-shell silica nanoparticles with improved Cu bioavailability: synthesis, characterization and study of antibacterial properties Journal of Biomedical Nanotechnology (accepted on Dec. 24, 2011)(2012).
10. L. M. Rossi, L. F. Shi, F. H. Quina, Z. Rosenzweig, Stober synthesis of monodispersed luminescent silica nanoparticles for bioanalytical assays Langmuir 21, 4277-4280 (2005).
11. M. Kawashita, S. Tsuneyama, F. Miyaji, T. Kokubo, H. Kozuka, K. Yamamoto, Antibacterial silver-containing silica glass prepared by sol,Äigel method Biomaterials 21, 393-398 (2000).
12. S. K. Rastogi, V. J. Rutledge, C. Gibson, D. A. Newcombe, J. R. Branen, A. L. Branen, Ag colloids and Ag clusters over EDAPTMS-coated silica nanoparticles: synthesis, characterization, and antibacterial activity against Escherichia coli Nanomedicine: Nanotechnology, Biology and Medicine 7, 305-314 (2011).
13. D. T. Sawyer, J. L. Roberts, Hydroxide ion: an effective one-electron reducing agent? Accounts of Chemical Research 21, 469-476 (1988).
14. S. Egger, Lehmann, R. P., Height, M. J., Loessner, M. J., & Schuppler, M., Antimicrobial properties of a novel silver-silica nanocomposite material. Applied and Environmental Microbiology 75, 2973-2976 (2009).

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to measurement techniques and the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

Therefore, at least the following is claimed:

1. A composition, comprising:
a copper/silica nanoparticle having a silica core and a copper/silica shell disposed around the silica core, wherein the copper is about 2 to 30 weight percent of the copper/silica nanoparticle, wherein the copper is uniformly loaded in the copper/silica shell.

2. The composition of claim 1, wherein the copper/silica nanoparticle has an antimicrobial characteristic.

3. The composition of claim 1, wherein the silica core has a diameter of about 10 nm to 1 μm and the copper/silica shell has a thickness of about 5 nm to 200 nm.

4. The composition of claim 1, wherein the copper/silica nanoparticle is spherical.

5. The composition of claim 1, wherein the copper in the copper/silica shell is about 5 to 20% more soluble than copper hydroxide.

6. The composition of claim 1, wherein the copper/silica nanoparticle has a minimum inhibitory concentration (MIC) value of about 2.4 μg metallic Cu/mL for both E. coli and B. subtilis.

7. A method of making a composition, comprising:
mixing a first silica precursor compound, an alcohol, ammonium hydroxide, and water;
forming a silica core;
separating the silica core from the remaining mixture;
mixing the silica core in an acidic solution with a copper precursor compound and a second silica precursor compound; and
forming a copper/silica nanoparticle having a silica core and a copper/silica shell disposed around the silica core, wherein the copper is about 2 to 30 weight percent of the copper/silica nanoparticle, wherein the copper is uniformly loaded in the copper/silica shell.

8. The method of claim 7, wherein the copper precursor compound is selected from the group consisting of: copper sulfate pentahydrate, copper nitrate, copper chloride, and combinations thereof.

9. The method of claim 7, wherein the first silica precursor compound and the second silica precursor compound are independently selected from the group consisting of: alkyl silane, tetraethoxysilane (TEOS), tetramethoxysilane, sodium silicate, a silane precursor that can produce silicic acid or silicic acid like intermediates, and a combination thereof.

10. The method of claim 7, wherein the silica core has a diameter of about 10 nm to 1 μm and the copper/silica shell has a thickness of about 5 nm to 200 nm.

11. A method, comprising:
disposing a composition on a surface, wherein the composition includes a copper/silica nanoparticle having a silica core and a copper/silica shell disposed around the silica core, wherein the copper is about 2 to 30 weight percent of the copper/silica nanoparticle, wherein the copper is uniformly loaded in the copper/silica shell; and
killing a substantial portion of a microorganism or inhibiting or substantially inhibiting the growth of the microorganisms on the surface of a structure or that come into contact with the surface of the structure.

12. The method of claim 11, wherein the microorganism is a bacterium.

13. The method of claim 11, wherein the microorganism selected from the group consisting of: E. coli, B. subtilis, and S. aureus.

14. The method of claim 11, wherein the copper/silica nanoparticle has a minimum inhibitory concentration (MIC) value of 2.4 μg metallic Cu/mL for both E. coli and B. subtilis.
